(19) United States
(12) Patent Application Publication
(10) Pub. No.: US 2026/0200775 A1
(43) Pub. Date: Jul. 16, 2026

(54) SYSTEMS AND METHODS FOR WATER TREATMENT

(71) Applicants: The Regents of the University of California, Oakland, CA (US); NATIONAL UNIVERSITY CORPORATION KANAZAWA UNIVERSITY, Kanazawa Ishikawa (JP)

(72) Inventors: Eric M V Hoek, Los Angeles, CA (US); Shaily Mahendra, Santa Monica, CA (US); Dukwoo Jun, Los Angeles, CA (US); Minhao Xiao, Los Angeles, CA (US); Kevin Clack, Los Angeles, CA (US); Richard B. Kaner, Los Angeles, CA (US); Ryo Honda, Ishikawa (JP)

(21) Appl. No.: 19/129,908

(22) PCT Filed: Nov. 15, 2023
(86) PCT No.: PCT/US23/79804

§ 371 Date: May 14, 2025

Related U.S. Application Data
(60) Provisional application No. 63/425,577, filed on Nov. 15, 2022.

(51) Int. Cl. C02F 3/12; C02F 3/28; C02F 3/32; C02F 9/00; C02F 101/10

(52) U.S. Cl. CPC C02F 3/1268; C02F 3/2813; C02F 3/322; C02F 9/00; C02F 2101/10; C02F 2301/08; C02F 2303/06; C02F 2303/18

(57) ABSTRACT

A wastewater treatment system includes an aerobic/high purity oxygen membrane bioreactor. The MBR configured to intake influent wastewater and normal air or high purity oxygen and output effluent comprising sludge solids, carbon dioxide and partially treated water. The system includes an ultrafiltration/microfiltration membrane algal photobioreactor (algal-MPBR) in fluid communication with the MBR. The algal-MPBR is configured to intake the carbon dioxide and the partially treated water and output reuse water and an algal biomass. The system includes an anaerobic digester, the anaerobic digester in fluid communication with the MBR and the algal-MPBR. The anaerobic digester configured to intake the sludge solids and the algal biomass and output fertilizer, biogas and indirect potable water.

### CROSS-REFERENCE TO RELATED APPLICATIONS

This application claims the benefit of U.S. Provisional Application No. 63/425,577, filed on Nov. 15, 2022, the entire contents of which are hereby incorporated by reference herein.

### BACKGROUND OF THE DISCLOSED SUBJECT MATTER

### Field of the Disclosed Subject Matter

The disclosed subject matter relates to systems and methods for wastewater treatment. Particularly, the present disclosed subject matter is directed to domestic wastewater treatment utilizing algal biomass cultivation and aerobic/high purity oxygen membrane bioreactors.

### DESCRIPTION OF RELATED ART

The original inspiration that led to the use of respiring bacteria to reduce the carbon organic content in wastewater was that bacteria in the environment naturally degrade sewage waste, but in doing so they reduce dissolved oxygen levels leading to hypoxic conditions. The original concept was thus to bring the bacteria into an engineered reactor and inject oxygen continuously to biodegrade most of the organic carbon before the wastewater is discharged into the environment. The modern wastewater treatment plant (WWTP) was born as the problem became the solution. Conventional activated sludge processes are employed successfully all around the world, but they remove only a small portion of nitrogen and phosphorus from sewage through assimilation by aerobic bacteria. This limited nutrient removal by activated sludge requires additional nutrient removal processes because nitrogen and phosphorus cause eutrophication in surface waters through algae blooms. Most biological nutrient removal (BNR) processes use specialized bacteria and throttling of oxygen levels to remove nutrients in tertiary wastewater treatment. However, the tertiary process applying BNR critically increases the operating cost of WWTP since BNR demands high amount of oxygen to oxidize the reduced nutrients in wastewater.

In recent years, private industry has made great strides in converting dissolved carbon dioxide (CO₂), nitrogen and phosphorous into algal biomass for conversion into biodiesel, biobutanol and other useful chemical products. The municipal wastewater industry is now exploring the use of algae for converting the residual nitrogen and phosphorous in secondary effluent into algal biomass while sequestering CO₂. Integrating high-rate algal cultivation with conventional wastewater treatment enables effective nutrient removal without oxygen supply and, furthermore, enables a WWTP to harvest additional energy from wastewater. Several studies have evaluated this concept finding significant benefits of the renewable energy produced from algal biomass, including carbon fixation and energy savings by replacing BNR which could recoup the cost of harvesting microalgae.

There thus remains a need for an efficient and economic method and system for domestic wastewater treatment utilizing algal biomass cultivation and aerobic/high purity oxygen membrane bioreactor.

### SUMMARY OF THE DISCLOSED SUBJECT MATTER

The purpose and advantages of the disclosed subject matter will be set forth in and apparent from the description that follows, as well as will be learned by practice of the disclosed subject matter. Additional advantages of the disclosed subject matter will be realized and attained by the methods and systems particularly pointed out in the written description and claims hereof, as well as from the appended drawings.

To achieve these and other advantages and in accordance with the purpose of the disclosed subject matter, as embodied and broadly described, the disclosed subject matter includes a wastewater treatment system, the system including membrane bioreactor (MBR, either an aerobic MBR, ae-MBR, or a high purity oxygen MBR, HPO-MBR), the MBR configured to intake influent wastewater and normal air or high purity oxygen and output effluent comprising sludge solids, carbon dioxide and partially treated water. The system including an algal membrane photobioreactor (algal-MPBR) in fluid communication with the MBR, the algal-MPBR configured to intake the carbon dioxide and the partially treated water and output potable water and an algal biomass. The system includes an anaerobic digester the anaerobic digester in fluid communication with the MBR and the algal-MPBR, the anaerobic digester configured to intake the sludge solids and the algal biomass and output fertilizer, biogas and indirect potable water.

The disclosed subject matter also includes a wastewater treatment method, the method includes providing wastewater to an MBR. The method includes providing normal air to the ae-MBR or pure oxygen to the HPO-MBR, aerating the wastewater, thereby incorporating the air/oxygen into the wastewater, exhausting output effluent, the output effluent comprising sludge solids, partially treated wastewater and gaseous carbon dioxide from the MBR, providing the partially treated wastewater to an algal membrane photobioreactor (algal-MPBR), cultivating algal biomass in the algal-MPBR, providing the sludge solids to an anaerobic digester, providing the algal biomass to the anaerobic digester, and exhausting fertilizer and biogas.

The disclosed subject matter also includes a wastewater treatment system, the system including a staged membrane bioreactor (MBR), the MBR having at least two stages in fluid communication, each stage configured to intake influent wastewater and air or high-purity oxygen, aerate the influent wastewater with the air or high-purity oxygen and output effluent comprising sludge solids, carbon dioxide and partially treated water, a membrane algal photobioreactor (algal-MPBR) in fluid communication with the staged MBR, the algal-MPBR configured to intake the carbon dioxide and the partially treated water and output reuse water and an algal biomass, an anaerobic digester, the anaerobic digester in fluid communication with the MBR and the algal-MPBR, the anaerobic digester configured to intake the sludge solids and the algal biomass and output at least one of fertilizer, biogas and indirect potable water.

It is to be understood that both the foregoing general description and the following detailed description are exemplary and are intended to provide further explanation of the disclosed subject matter claimed.

The accompanying drawings, which are incorporated in and constitute part of this specification, are included to illustrate and provide a further understanding of the method and system of the disclosed subject matter. Together with the description, the drawings serve to explain the principles of the disclosed subject matter.

### BRIEF DESCRIPTION OF THE DRAWINGS

A detailed description of various aspects, features, and embodiments of the subject matter described herein is provided with reference to the accompanying drawings, which are briefly described below. The drawings are illustrative and are not necessarily drawn to scale, with some components and features being exaggerated for clarity. The drawings illustrate various aspects and features of the present subject matter and may illustrate one or more embodiment(s) or example(s) of the present subject matter in whole or in part.

FIG. 1 is a schematic representation of the wastewater treatment system in accordance with the disclosed subject matter.

FIG. 2 is a schematic representation of an aerobic (aerobic/high purity oxygen) membrane bioreactor in accordance with the disclosed subject matter.

FIGS. 3A and 3B are mass flow diagrams of the wastewater treatment system with an anaerobic membrane bioreactor and high-purity oxygen membrane bioreactor, in accordance with the disclosed subject matter.

FIG. 4 is a representation of mass flow diagrams of CO₂ capture and biomass production in wastewater treatment plants in accordance with the disclosed subject matter.

FIG. 5 is a graphical representation of oxygen transfer limiting envelopes for biological treatment processes.

FIG. 6 is a method for wastewater treatment in accordance with the disclosed subject matter.

FIG. 7A-7B are plots of mixed liquor volatile suspended solids (MLVSS) and Food to Microorganism (F/M) ratio vs mean cell retention time (MCRT) and MLVSS vs chemical oxygen demand (COD).

FIG. 8 is a plot of methane production vs organic loading rate (OLR) for a typical wastewater treatment plant and the wastewater treatment system as describe herein (sustainable water recycling and resource recovery or “SWR3”).

FIG. 9 schematic diagram of an embodiment of a wastewater treatment system including sub-processes not included in the description of FIG. 1, in accordance with the disclosed subject matter.

FIG. 10 is a plot of power demand vs. MCRT for three types of bioreactor processes.

FIG. 11A-11B are plots of MLVSS and alpha factor vs. OLR and power demand vs. OLR, respectively in accordance with the disclosed subject matter.

FIG. 12 is a bar graph of percent of total plant energy for an ae-MBR/algal MPBR and HPO-algal MPBR in accordance with the disclosed subject matter.

FIG. 13A-13C are pie charts of compositions of (a) raw digester biogas, (b) purified biogas, and (c) normal air in accordance with the disclosed subject matter.

FIG. 14A-14D are plot of power production and consumption for a plurality of processes in accordance with the disclosed subject matter.

FIG. 14E is a bar graph illustrated energy consumption, energy production and net energy recovery for HPO and aerobic bioreactors in accordance with the disclosed subject matter.

FIG. 15A-15B are schematic diagrams of embodiments of a wastewater treatment system in accordance with the disclosed subject matter.

FIGS. 16A-16B are pie charts representing distribution of energy demand of a wastewater treatment plant employing CAS process and conventional MBR energy contribution, in accordance with the disclosed subject matter.

FIG. 17 is a bar graph representing methane production related to three scenarios corresponding to embodiments of the wastewater treatment system, in accordance with the disclosed subject matter.

FIGS. 18A-18B are pie charts representing compositions of raw digester biogas and purified biogas, respectively, in accordance with the disclosed subject matter.

FIG. 19 is a bar graph representing energy demand and production in accordance with embodiments of the wastewater treatment plant, in accordance with the disclosed subject matter.

FIGS. 20A-20C are bar graphs representing energy recovery in various embodiments of the wastewater treatment systems, in accordance with the disclosed subject matter.

FIG. 21 is a plot depicting the relationship between primary detention time with COD/TSS removal efficiency, in accordance with the disclosed subject matter.

FIG. 22 is a plot depicting the relationship between F/M ratio and MLVSS versus MCRT, in accordance with the disclosed subject matter.

FIG. 23 is a plot depicting MLVSS in relation to OLR/COD for an HRT of 5 hours and MCRT of 20 days, in accordance with the disclosed subject matter.

FIG. 24 is a schematic diagram of a wastewater treatment plant.

FIG. 25 is a schematic diagram of an activated sludge process (ASP) in accordance with the disclosed subject matter.

FIG. 26 is a plot depicting MLVSS and F/M ratio versus MCRT, in accordance with the disclosed subject matter.

FIG. 27 is a plot of organic loading rate, depicting MLVSS versus COD, in accordance with the disclosed subject matter.

FIG. 28 are schematic diagrams of CO₂ capture and biomass production in various embodiments of wastewater treatment plants, in accordance with the disclosed subject matter.

FIG. 29 is a plot of bio-methane production in various embodiments of wastewater treatment plants, in accordance with the disclosed subject matter.

FIG. 30 is a schematic representation of mass flow in various embodiments of the wastewater treatment system in accordance with the disclosed subject matter.

FIG. 31 is a bar graph representing specific biomass yields with various processes in accordance with the disclosed subject matter.

### DETAILED DESCRIPTION

Reference will now be made in detail to exemplary embodiments of the disclosed subject matter, an example of which is illustrated in the accompanying drawings. The method and corresponding steps of the disclosed subject matter will be described in conjunction with the detailed description of the system.

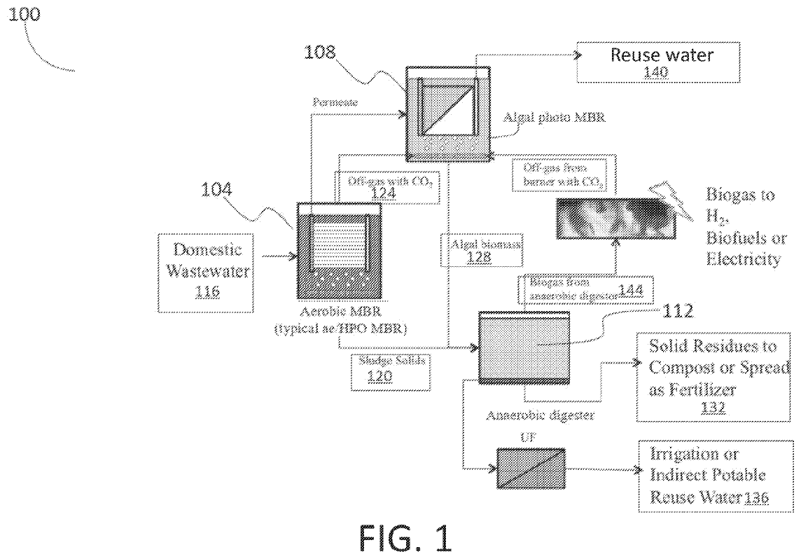

The methods and systems presented herein, may be used for wastewater treatment systems and methods. The disclosed subject matter is particularly suited for organic-containing wastewater treatment requiring biological treatment for the primary purpose of organic removal, which could be domestic, municipal or industrial in origin. For purpose of explanation and illustration, and not limitation, an exemplary embodiment of the system in accordance with the disclosed subject matter is shown in FIG. 1 and is designated generally by reference character 100. Similar reference numerals (differentiated by the leading numeral) may be provided among the various views and Figures presented herein to denote functionally corresponding, but not necessarily identical structures. In various embodiments described herein, amounts and units are utilized for exemplary illustrations of the disclosed system and method. One of skill in the art would appreciate that these values and units to describe the system and method may be scalable, configurable or otherwise exemplary, and none seek to limit the herein disclosed system and method.

FIG. 1 depicts a schematic diagram of representation of the wastewater treatment system 100. System 100 includes aerobic membrane bioreactors ae-MBR/HPO-MBR, anaerobic membrane bioreactors (anaerobic digesters) and membrane-based algal cultivation (algal-MPBR).

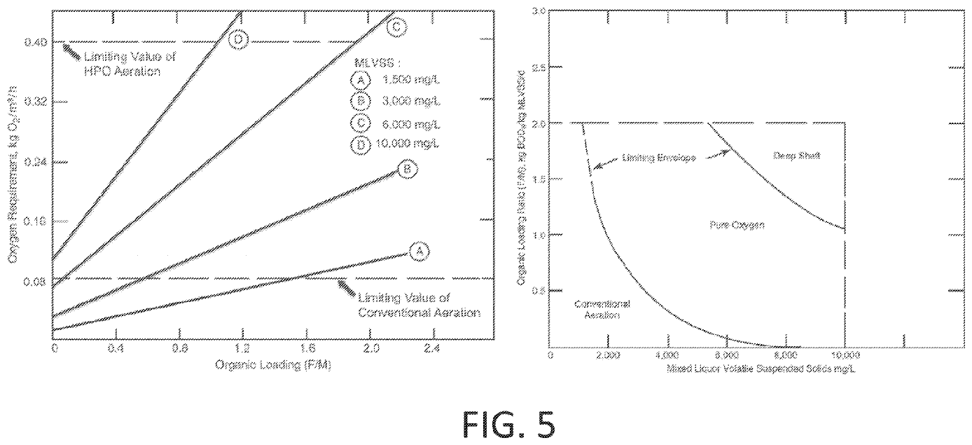

With continued reference to FIG. 1, system 100 includes aerobic membrane bioreactors ae-MBR/HPO-MBR 104. Aerobic membrane bioreactors ae-MBR/HPO-MBR 104 may be configured as a multi-chambered or staged membrane bioreactor. A membrane bioreactor (MBR) has been widely applied in wastewater treatment processes, since MBR enables the process to achieve better water quality and smaller footprint than conventional activated sludge (CAS) processes. MBR provides wastewater treatment process a transformative advantage of maintaining much higher mixed liquor volatile suspended solids (MLVSS) in bioreactor than CAS process; however, this high level of MLVSS restricts the oxygen transfer rate, which can limit the food to microorganism (F/M) ratio and organic loading rate (OLR). Therefore, MBR generally runs at lower F/M ratio than CAS process to maintain proper oxygen transfer efficiency. The preferred F/M ratio range in a MBR is approximately a third to a half of that in CAS, (i.e., 0.05-0.15 kg BOD/kg MLVSS/day), wherein BOD is biological oxygen demand, or the amount of oxygen required by one or more organisms, such as bacteria, to decompose the organic compounds in the water. Oxygen transfer limits can be seen in the plots depicted in FIG. 5. First, MBR process can control MCRT readily without any clarifiers because the membrane system can filter most, even approaching 99%, of microbial sludge and securely retain it in the bioreactor. Second, the use of pure oxygen can keep a sufficient DO in bioreactor due to its advanced capability of oxygen supply. While the average DO concentration is approximately 0.5-3.0 mg/L for CAS process, that of HPO process is around 4-8 mg/L. Third, because thick foaming and filamentous bulking can be addressed with higher DO concentration in bioreactor, the enhanced DO concentration with pure oxygen is able to increase F/M ratio with secure sludge characteristics.

With continued reference to FIG. 1, aerobic membrane bioreactors ae-MBR/HPO-MBR 104 are configured to intake influent wastewater 116. Wastewater 116 may be any domestic, municipal or industrial wastewater including suspended solids (MLVSS) traveling with any underground or otherwise disposed municipal or private infrastructure. Wastewater, for the purposes of this disclosure, refers to any water generated after the use of freshwater, raw water, drinking water, or saline water in deliberate applications or processes such as any combination of domestic, industrial, commercial, or agricultural activities, surface runoff/storm water, and any sewer inflow or sewer infiltration. Influent wastewater 116 may include a chemical oxygen demand (COD) of 350 mg/L, a total nitrogen (TN) of 35 mg N/L, an HRT of 5 hours, and an MCRT of 15 days for ae-MBR and a chemical oxygen demand (COD) of 500 mg/L, a total nitrogen (TN) of 50 mg N/L, an HRT of 5 hours, and an MCRT of 15 days for HPO-MBR.

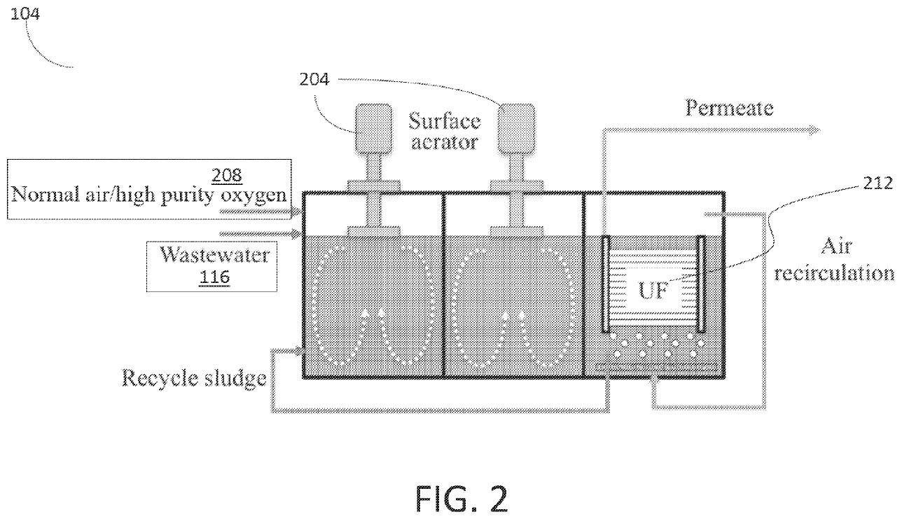

With continued reference to FIG. 1, aerobic membrane bioreactors ae-MBR/HPO-MBR 104 are configured to intake normal air/high purity oxygen (HPO) to mix said oxygen with the influent wastewater 116. For the purposes of this disclosure, the reference character 104 may be utilized for both an aerobic MBR (ae-MBR) and a high purity oxygen MBR (HPO-MBR 104), the difference between the MBRs being the configuration of taking in normal air versus high purity oxygen to mix with the influent waste water, respectively. The use of pure oxygen can significantly advance the oxygen transfer rate and finally organic loading rate. Aeration with pure oxygen provides higher gas phase oxygen concentrations than air systems and increases the oxygen mass transfer driving force, allowing faster treatment rates with higher mixed liquor suspended solids (MLVSS). Therefore, the use of high purity of oxygen can achieve high F/M ratio as well as a high oxygen transfer efficiency, both of which help treat high COD loading wastewater 116 without depleting the dissolved oxygen in bioreactor. Aerobic membrane bioreactors ae-MBR/HPO-MBR 104 may include a plurality of distinct chambers in fluid communication with each other. For example, influent wastewater such as wastewater 116 may flow or be pumped into a first chamber comprising an aerator, such as a surface aerator 204 in FIG. 2.

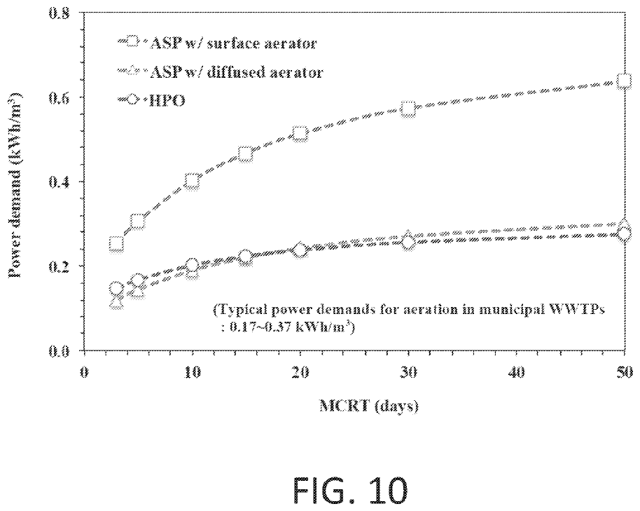

Surface aerator 204 is configured to agitate, spin, and thoroughly mix the wastewater 116 with either normal air or high purity oxygen 208, which is being pumped into said first chamber. The power demand for typical aeration and HPO aeration can be seen compared in reference to FIG. 10. The power demand for high-purity oxygen is much lower than typical aeration w/surface aerator, and similar to typical aeration w/diffused aerator. The aerated wastewater 116 may then be subsequently pumped, flowed, or otherwise transported to a second or successive chambers for aeration utilizing a second aerator such as surface aerator 204 in FIG. 2. The normal air/HPO 208 mixed with the wastewater 116 within the one or more aeration chambers of ae-MBR/HPO-MBR 104 may then be pumped into a final chamber comprising at least a membrane such as an ultrafiltration (UF) component 212.

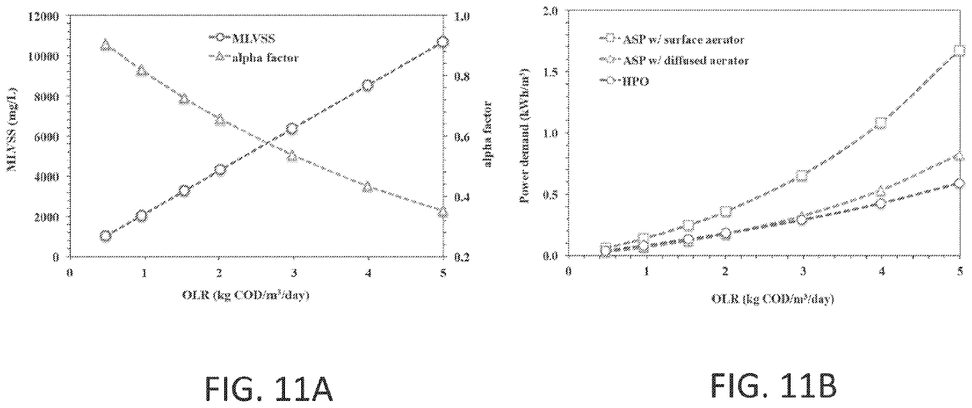

Another factor affecting MLVSS in bioreactor is organic loading rate (OLR) and, generally, higher OLR raises more sludge since increased OLR implies more abundant feeding substrates to microorganisms in bioreactor. This direct relationship between OLR and MLVSS can form an indirect correlation between OLR and the actual mass transfer coefficient because of the impact of MLVSS on the actual mass transfer rate as mentioned previously. FIG. 11a shows that the added biomass contents with increase in OLR hinder the oxygen mass transfer in aeration process and that, finally, the power demand for aeration rises with OLR for all cases of aeration options (FIG. 11b).

The UF component 212 is configured to separate and exhaust sludge solids 120, partially treated water (which may contain dissolved CO₂), and gaseous components, herein referred to as off-gas, which may also contain gaseous CO₂ 124. This partially treated wastewater 116 may permeate the final membrane in the ae-MBR/HPO-MBR 104 and comprise N and P, as well as dissolved CO₂, including but not limited to, the same amount of CO₂ as found in an equal volume of air. In some embodiments, the effluent partially treated wastewater from ae-MBR/HPO-MBR 104 may include over 20% dissolved CO₂ suspended therein.

For the purposes of this disclosure, sludge solids 120, is the residual, semi-solid material that is produced as a by-product during sewage treatment of wastewater. The term “septage” may also refer to sludge from simple wastewater treatment but is connected to simple on-site sanitation systems, such as septic tanks. When fresh sewage or wastewater 116 enters a primary settling tank, a portion thereof settles. This collection of solids is known as raw sludge or primary solids and is said to be “fresh” before anaerobic processes become active. The sludge will become putrescent in a short time once anaerobic bacteria take over, and must be removed from a sedimentation tank, if present, before this happens.

In some embodiments, the fresh sludge is continuously extracted from the bottom of a settling tank by mechanical scrapers and passed to separate sludge-digestion tanks, or one or more downstream components as described herein, such as an anaerobic digester or anaerobic membrane bioreactor 112. In some embodiments, the tank is configured to force the sludge to settle through a slot into a lower story or digestion chamber, where it is decomposed by anaerobic bacteria, resulting in liquefaction and reduced volume of the sludge. In embodiments, the sludge may be primarily or secondarily clarified in primary and secondary clarifiers, respectively. Primary clarification, also known as sedimentation, is the first step in the water treatment process for removing settleable solids (SS) and floatables (i.e., oil and grease). Sludge is settled to the bottom of the clarifier basins and collected by a rake and removed by a sludge removal system. Meanwhile, oil and grease float to the surface and is skimmed off. Secondary clarification follows the aerobic biological treatment process with the main goal removing activated sludge from the secondary treated effluent and returning at least a portion of the activated sludge to the one or more aeration chambers. During the secondary clarification process the biomass from microorganisms settles to the bottom. After settling over a period of time, the biomass of microorganisms is returned to the aeration tank with the cycle repeating until the effluent is clean before sent for filtration and/or disinfection. Waste sludge is removed and thickened prior to the digestion process.

In some embodiments, the sludge is largely composed of bacteria and protozoa with entrained fine solids, and this is removed by settlement in secondary settlement tanks. Both sludge streams are combined and are processed by anaerobic or aerobic treatment process at either elevated or ambient temperatures. After digesting for an extended period, the result is digested sludge and may be disposed of by drying and then landfilling, composting or land application as fertilizer, in embodiments.

Ae-MBR/HPO-MBR 104 may include a sludge return pipe. Sludge return may be disposed in the final chamber, in embodiments of a staged ae-MBR/HPO-MBR 104, returning sludge that does not meet the requirements for piping to the anaerobic digester 112. For example, portions of the sludge may not be aerated, separated, or treated enough to pass through one or more filters, gravity-type separators, or the like, effectively sorting sludge for further processing and sludge solids 120. For example, sludge solids 120 may sink to the bottom most portion of the tank, wherein the pipe to anaerobic digester 112 is disposed. The sludge return pipe may be disposed above said anaerobic digester 112 pipe, taking in the sludge that is not treated enough. The sludge return pipe may then be connected back to one or more, earlier stages of ae-MBR/HPO-MBR 104 such as the first stage or second stage for further in aeration in FIG. 2.

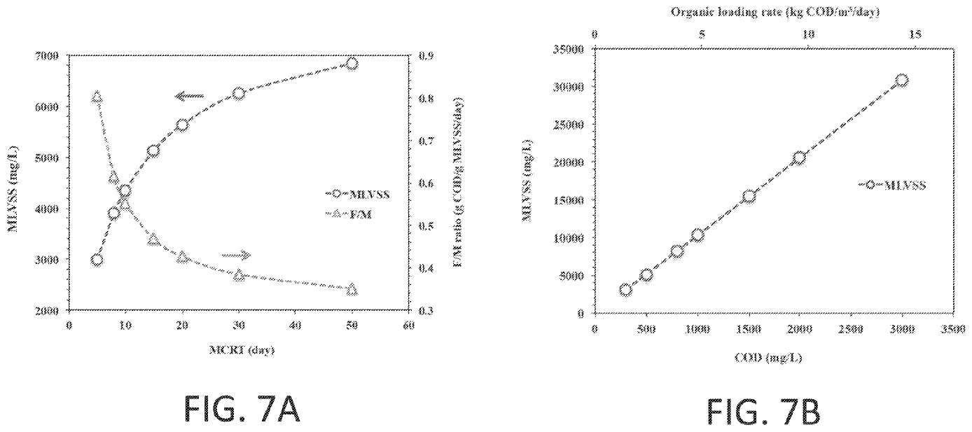

In embodiments, the effect of organic loading rate on MLVSS to estimate the membrane fouling potential in ae-MBR/HPO-MBR. Under assumption that HPO-MBR can improve the F/M ratio of the ae-MBR, this method applied 0.47 g COD/g MLVSS/day of F/M ratio, which needs 15 days of MCRT. Although they also change dynamically with organic loading rate (OLR) in reality, this simulation assumed constant microbial activities (i.e., KD, Y) with different OLR to avoid a complex modeling. FIG. 7 shows that MLVSS grows proportionally with increase in OLR. Even though it is true for higher biomass concentration in bioreactor to cover higher substrate loading rate, excessive microorganism contents cause a severe membrane fouling and a rising energy cost so that MBR processes typically run 6,000 to 10,000 mg MLVSS/L of biomass. In embodiments, the maximum OLR of satisfying the stable MLVSS (10,000 mg MLVSS/L) is 5 kg COD/m³/day, which is more than twice as enhanced as the typical OLRs of MBRs (1.0~2.5 kg COD/m³/day), as can be readily seen in FIG. 7b.

Despite several advantages of ae-MBR/HPO-MBR, a major operational challenge for ae-MBR/HPO-MBR process is its limited capability of nitrification. A staged enclosed reactor is commonly used in the air/HPO activated sludge process as presented in FIG. 2. For the purposes of this disclosure, “activated sludge process” is the process of treating wastewater using aeration and biological material such as microorganisms to oxidize organic pollutants, producing sludge solids 120. The off-gas mainly contains the carbon dioxide produced by the biological reactions. The retention of CO₂ within the system may result in depression of the pH; values in the 6.0 to 6.5 are not unusual unless pH control is practiced. This pH drop in bioreactor suppresses the activity of nitrifying bacteria so that ammonia in influent wastewater 116 is rarely oxidized to nitrite and nitrate. Limitation of nitrification in air/HPO demands greater capabilities of BNR processes and complicates the operating conditions of BNR processes to remove nitrogen from wastewater than is necessary.

Nitrogen compounds in municipal wastewater consist mainly of ammonium ion, ammonia and organic nitrogen, which are the reduced forms of nitrogen. Aerobic biological processes can remove only a portion of nitrogen in sewage as much as nitrogen is assimilated to the carbonaceous microbes since the aerobic microbes can assimilate only oxidized forms of nitrogen. In contrast to those aerobic microorganisms, the microalgae are capable to use either the ammonia-nitrogen or the nitrate-nitrogen and the most favorite nitrogen compound that microalgae assimilate is ammonium (NH₄⁺). Therefore, the integrating ae-MBR/HPO-MBR with algal treatment process can overcome the nitrifying limitation of the aerobic process and also enhance the nutrient removal.

Furthermore, high amount of the dissolved CO₂ in ae-MBR/HPO-MBR effluent because of the high CO₂ content in headspace of aerobic process can reduce the additional CO₂ supply needed for the algal treatment process. Microalgae need inorganic carbon species such as CO₂ and HCO₃⁻ as carbon sources and they prefer dissolved CO₂ to HCO₃⁻, which demands the enzyme carbonic anhydrase to convert it to CO₂. Typical method of CO₂ supply is aeration of normal air since air contains about 20% of CO₂ and this aeration covers important cost contribution to algal treatment process. However, ae-MBR/HPO-MBR effluent is expected to already contain abundant amount of dissolved CO₂ so that the use of ae-MBR/HPO-MBR effluent can save critically the aeration demand and its cost.

Most feasibility studies on integration of microalgae into municipal WWTPs have built their scenarios on simplified assumptions that do not consider all the relevant technical factors such as the limitation of phosphorus and nitrogen loading rates on algal biomass yield. Since low concentrations of nutrients in partially treated wastewater limit algal biomass yield, methods of intensifying the process by concentrating nutrient within the algal photobioreactor using immersed ultrafiltration membranes may be utilized according to the disclosed subject matter.

With continued reference to FIG. 1, system 100 includes algal membrane photo bioreactor (algal-MPBR) 108. Algal-MPBR 108 may include at least one immersed ultrafiltration/microfiltration membrane. Algal-MPBR 108 may be configured to intake the output partially treated wastewater from the ae-MBR/HPO-MBR 104 and off-gas 124. Algal-MPBR 108 may include at least microalgae within at least one chamber. Microalgae may be circulated throughout the chamber, may be disposed within the chamber in an inner chamber, such as a chamber with perforations such that the partially treated wastewater may flow through said perforated chamber. The microalgae within algal-MPBR 108 remove nitrogen (N) and phosphorous (P) from said partially treated wastewater. For algal-MPBR 108, the production rate of microalgae can be readily estimated with nitrogen loading rate, which is known to regulate the maximum growth rate of microalgae in photo-bioreactor. Algal biomass yield ranges from 5 g TSS/g N to 12 g TSS/g N and the value is dependent on total nutrient loading rate and substrate balance (C:N:P). Advantages and disadvantages of SWR3 are very sensitive to the loading rates of organic substrate and nutrients because they determine the oxygen requirement and biomass yield, which critically contribute to the benefits and challenges of SWR3. Therefore, this method generated a library of the loading rates with differentiating the concentrations of organic compounds and nutrients. The microalgae form algal biomass 128 from the dissolved N and P with higher carbon content as absorbed from both dissolved CO₂ with the partially treated wastewater and gaseous CO₂ vented with off-gas 124. In some embodiments, and due to low concentrations of nutrients in partially treated wastewater limiting algal biomass 128 yield, nutrients may be first concentrated within one or more ultrafiltration/microfiltration (UF/MF) membranes with algal-MPBR 108. Said nutrients may be collected from subsequently smaller and smaller membranes in the direction of the flow of the partially treated wastewater, the nutrients collected at their respectively sized membranes. The microalgae may then be exposed to said concentrated areas. In some embodiments, the concentrated areas may be within the microalgae chamber, or the microalgae may be directed toward the membranes.

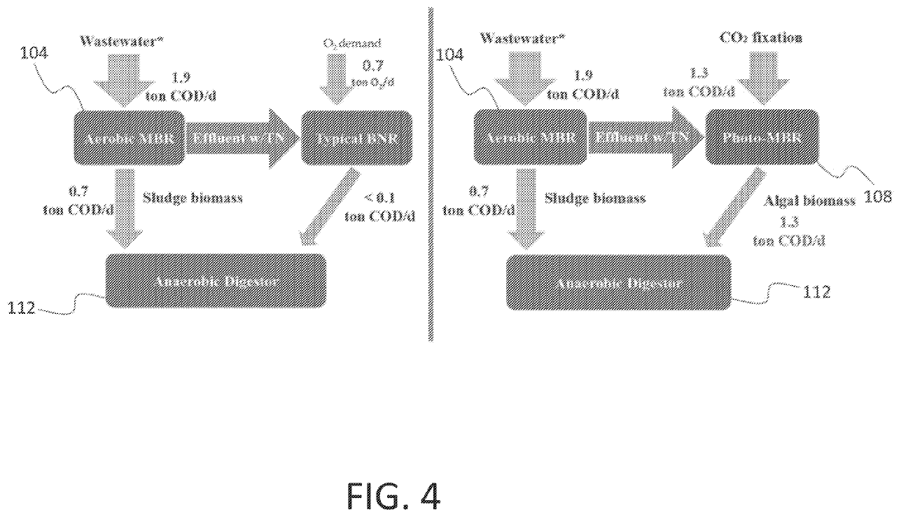

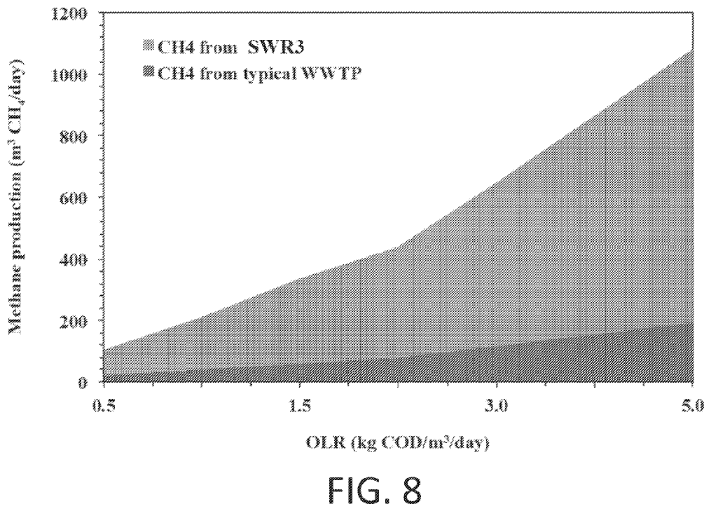

In various embodiments, integrating a microalgae system to ae-MBR/HPO-MBR improves the energy required by the system by reducing the need for oxygen. While BNR in a conventional WWTP may demand the oxygen of over 0.103 kg/m³/day, MPBR does not require any oxygen to remove the nutrients as shown in FIG. 4, comparing BNR to MPBR. Furthermore, the high yield of algal biomass in MPBR can effectively convert nutrients at the secondary effluent to biomass that is available to be used as bioenergy resource. This high level of biomass yield is led by the facts that microbial growth rate of microalgae is generally higher than that of nitrifying bacteria and that microalgae utilizes CO₂ gas as its carbon source in comparison to nitrifying bacteria requiring organic compounds. Consequently, MPBR is presented to enhance the biogas 144 production in SWR3 about three times that in the typical WWTP as shown in FIG. 8.

Additionally, algal-MPBR 108 is configured to expose said microalgae to light, whether in the same or a distinct chamber as the partially treated wastewater, or concentrated nutrients. In some embodiments, the light may be natural light, such as direct sunlight, mirrored sunlight, and/or sunlight passed through one or more lenses. In some embodiments, the light may be artificial light such as LED, incandescent, high-pressure sodium, compact fluorescent lamps, fluorescent tubes, discharge lamps, or the like. The artificial light may be powered by one or more types of energy produced as a byproduct of the system described herein, or from an external power source such as the power grid, generator, batteries, or photovoltaic arrays. In some embodiments, algal-MPBR 108 includes an open or partially open configuration such that the topmost portion of the algal-MPBR 108 is open to the sun and/or elements. In some embodiments, algal-MPBR 108 includes one or more openings, windows, or pathways for light to travel through and expose the microalgae thereto. Algal-MPBR 108 may be a raceway pond, natural pond, artificial pond, or pit containing the partially treated wastewater and microalgae. In some embodiments, as described herein, algal-MPBR 108 may be configured with a closed configuration. For example, and without limitation, algal-MPBR 108 may include one or more chambers to hold said partially treated wastewater and microalgae. Algal-MPBR 108 may be configured to capture dissolved CO₂ within the partially treated wastewater from ae-MBR/HPO-MBR 104. Algal-MPBR 108 may also include headspace for the introduction of naturally-occurring or off-gas CO₂, on which the microalgae are required to absorb. Algal-MPBR 108 may be configured to sequester a large amount of CO₂ in algal biomass 128 during nutrient removal. In some embodiments, algal-MPBR 108 may include a tubular configuration wherein the partially treated wastewater is passed through the tubing which contain microalgae and are provided the nutrients and carbon dioxide from said wastewater and off-gas from the ae-MBR/HPO-MBR 104. Algal-MPBR 108 may be temperature, humidity, pH, or otherwise controlled to optimize algal biomass cultivation. Algal-MPBR 108 may be configured to resist membrane fouling. Membrane fouling is the phenomena of particulates, particles, and solute macromolecules deposited on or in the pores of the membrane, thereby blocking said pores and reducing the effective surface area of the membrane to separate particles from a solution. The algal-MPBR 108 may resist membrane fouling by including one or more mechanical components configured to shake, vibrate, or otherwise dislodge particles physically. In some embodiments, the algal-MPBR 108 may employ one or more chemical treatments configured to dislodge the particles stuck within the pores of the membrane.

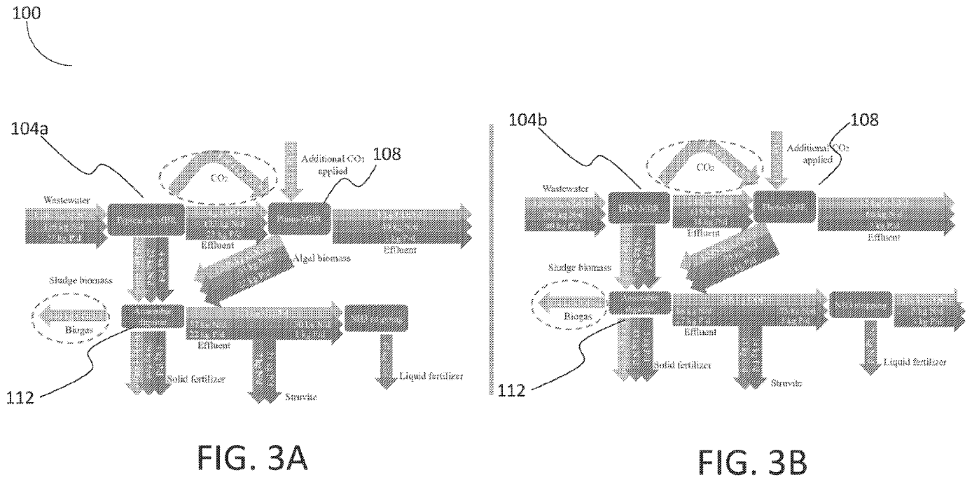

With continued reference to FIG. 1, algal-MPBR 108 has another potential benefit, the high rate of CO₂ sequestration. In various embodiments, if there is no limit of supplying CO₂ gas into MPBR, the microalgae system can capture a large amount of carbon dioxide per day, for example: 0.48 kg CO₂/m³/day (about 0.39 kg COD/m³/day) with HPO-MBR and 0.32 kg CO₂/m³/day (about 0.26 kg COD/m³/day) with ae-MBR, which are enough to compensate the CO₂ emission from activated sludge process as shown in FIGS. 3A and 3B. One of ordinary skill in the art would appreciate these values to be relative and exemplary only, and the flow rate of any one portion of the system may affect the output and efficiency of any other portion. In this exemplary embodiment, no demand of oxygen and external carbon compounds, enhanced biogas 144 production and high rate of CO₂ capture are shown to contribute to the high level of carbon-neutrality of SWR3.

With continued reference to FIG. 1, algal-MPBR 108 is configured to output non-potable reuse quality water 140. Reuse water 140, for the purposes of this disclosure, is water that is safe to drink or used in food preparation. Reuse water 140 may be treated to meet one or more government standards for potable water, such as state and federal standards and or guidelines. The reuse water 140 may be used for one or more processes of system 100, such as provided power using a water wheel or in a hydroelectric system, for example. Reuse water 140 may be pumped, flowed, or otherwise transported back into environmental water sources such as reservoirs, rivers, creeks, lakes, ponds, seas, oceans, or underground, such as in springs, aquifers, or the like. Reuse water 140 may be transported to one or more municipal water treatment facilities for further use as an energy source.

With continued reference to FIG. 1, system 100 includes an anaerobic membrane bioreactor (also discussed herein as anaerobic digester) 112. Anaerobic digester 112 may be configured as a tank with a substantially vertical arrangement, the intakes thereof for sludge solids 120 disposed at the tank's side, the algal biomass 128 intake being substantially similar. In some embodiments, the intake to anaerobic digester 112 may be formed by one or more pipes, circular cross-section or otherwise. In some embodiments, the intakes to anaerobic digester 112 may be disposed at the topmost portion of the tank. In some embodiments, the intakes to anaerobic digester 112 may be disposed at the bottom most portion of the tank. In some embodiments, the anaerobic digester 112 may include one or more chambers configured to contain the sludge/water/algal biomass, before during, or after digestion.

Anaerobic digester 112 may be configured to intake sludge solids 120 from ae-MBR/HPO-MBR 104. The sludge solids 120 may be agitated by a mixer, jets, or other mechanical or fluid agitator configured to mix said sludge solids with algal biomass 128. Anaerobic digester 112 may be configured to capture biogas 144 produced from the digestion of the particulates in the sludge by the algal biomass, the algal biomass 128 containing, in some embodiments, large amounts of CO₂ from the algal-MPBR 108. Anaerobic digester 112 may be configured to capture biogas 144 in one or more portions of the tank digestion takes place, or one or distinct chambers or tanks. For example, biogas 144 may rise from the liquid disposed in a lower portion of the anaerobic digester 112 and out a vent such as a pipe, duct, or other pathway to one or more downstream components. Anaerobic digester 112 may be a net energy producer, compensating from about 25 to 50% of total energy needs by using the produced biogas 144 from the anaerobic digester 112. PMBR has a great potential of altering COD mass flow of WWTP by sequestering a huge amount of CO₂ to algal biomass during nutrient recovery. This extensive fixation of CO₂ in algal biomass is equal to excessive conversion of CO₂ to organic sources, with which anaerobic digestion can harvest a considerable bio-energy and satisfy more portions of energy needs in WWTPs.

For the purposes of this disclosure, biogas 144 is a mixture of gases, primarily methane, carbon dioxide, and hydrogen sulfide produced from raw materials. Production of biogas 144 may be correlated to the production of algal biomass in algal-MPBR 108. Biogas 144 may be transported by pipe, duct, or vent to one or more downstream components such as a furnace, compressor, or the like. Biogas 144 may be further processed into usable forms of gas, for example hydrogen gas, biofuel, and/or burned to generate electricity. The gaseous byproducts of said processes may be vented back to one or more components of system 100, such as algal-MPBR 108. For example, the CO₂ vented from the one or more biogas 144 use components to the algal-MPBR 108 to cultivate algal biomass from the microalgae.

For the case of system, 100, employing MPBR, biogas 144 production and its energy generation change very little with MCRT since the decreased amount of wasted sludge from aerobic basin (aerobic or HPO-MBR's) is compensated with the added amount of algal biomass from MPBR. Above all, for all values of simulated MCRTs, energy production in SWR3 is sufficient to cover the power demand for aeration (200 to 300% of aeration power demands). Typical WWTP applying BNR is unable to catch its soaring energy consumption for aeration up with biogas 144 production and the gap between energy needs and generations becomes wider with increase in OLR.

With further reference to FIG. 1, anaerobic digester 112 is configured to generate and output fertilizer 132 in one or more of solid and liquid form. For example, the byproduct of the anaerobic digester 112 may include solids that may be spread as fertilizer or further processed to generate solid fertilizer 132. Anaerobic digester 112 may be also configured to generate liquid fertilizer. In some embodiments, wherein liquid fertilizer is generated, one or more UF processes may be employed to remove the finals solids from the partially treated water. The solids removed may then be disposed of or spread as fertilizer and the liquid, even if not as potable as the water output from algal-MPBR 108, but may still be used as indirect potable water 136.

Referring now to FIGS. 3A and 3B, two mass flow diagrams of exemplary embodiments of system 100 are shown in block diagram form. One of skill in the art would appreciate that these masses, rates, and other variables are only illustrative examples of the system as described herein and these flows may be generalized as the influent and effluent to each component. One of ordinary skill in the art would appreciate as well that the flows as described herein may be subject to the scale of the system, and the adjustment of any one of the components may result in varying flows, all of which are meant to be covered by this disclosure. Referring specifically now to FIG. 3A, an embodiment of the system 100 including an aerobic MBR (ae-MBR) is shown, this ae-MBR is designated 104a. Wastewater, which may be the same or similar to wastewater 116 flows into ae-MBR 104 at 1,262 kg COD/day and 126 kg N/d. The wastewater 116 includes MLVSS from domestic and commercial waste. The ae-MBR 104a operates as described herein, off-gas CO₂ is removed at 1,004 kg COD/d. This off-gas CO₂ may be mixed with ambient air, which also contains CO₂. This off-gas CO₂ may be vented or piped to one or more downstream components such as algal-MPBR 108 at 1,070 kg COD/d. Ae-MBR 104a is configured to aerate and separate partially treated wastewater (effluent) and exhaust said effluent at 103 kg N/d and 4 kg COD/d (ae-MBR) to algal-MPBR 108. The sludge biomass (sludge solids 120 from FIG. 1) is removed from ae-MBR 104a and transported to the anaerobic digester 112 at 254 kg COD/d and 23 kg N/d.

With continued reference to FIG. 3A, the algal-MPBR 108 intakes the effluent (partially treated wastewater), which mixes with microalgae disposed in one of a chamber, pond or other water receptacle exposed to light as described herein. The algal-MPBR 108 cultivates algal biomass as described herein, the microalgae takin N and P out of the effluent, as well as CO₂, the nutrients being concentrated as described herein by at least a membrane, like an ultrafiltration/microfiltration membrane. The algal biomass is then transported to the anaerobic digester 112 at 1,320 kg COD/d and 63 kg N/d. The anaerobic digester 112 digests the sludge solids utilizing the algal biomass transported therein. In some embodiments the algal biomass and sludge solids 120 are mixed mechanically. In some embodiments, paddles are used in a continuous rotation to agitate said sludge solid/algal biomass mixture. In some embodiments, a fluid jet is used to agitate the mixture. Anaerobic digester 112 exhausts effluent water at 352 kg COD/d and 57 kg N/d. In some embodiments, the effluent water is then stripped of ammonia (NH₃), the resultant effluent used as liquid fertilizer at 47 kg N/d. Additionally, the anaerobic digester 112 exhausts solid fertilizer (the remaining solids after digestion) at 319 kg COD/d and 29 kg N/d. Anaerobic digester 112 also captures and exhausts biogas 144 as a result of the digestion. The biomass may be vented to one or more other components to convert to other types of gas such as bio-methane and biofuel, as well as used in furnaces to generate electricity at 649 kg COD/d.

Now referring specifically to FIG. 3B, an embodiment of the system 100 including a HPO-MBR is shown, the HPO-MBR is designated 104b. Wastewater, which may be the same or similar to wastewater 116 flows into HPO-MBR 104b at 1,893 kg COD/day and 189 kg N/d, and 40 kg P/d into HPO-MBR 104b. The wastewater 116 includes MLVSS from domestic and commercial waste. The HPO-MBR 104b operates as described herein, off-gas, CO₂ is removed at 1,496 kg COD/d. This off-gas CO₂ may be mixed with ambient air, which also contains CO₂. This off-gas CO₂ may be vented or piped to one or more downstream components such as algal-MPBR 108 at 1,595 kg COD/d from the HPO-MBR 104b. HPO-MBR 104b is configured to aerate and separate partially treated wastewater (effluent) and exhaust said effluent at 155 kg N/d and 5 kg COD/d to algal-MPBR 108. The sludge biomass (sludge solids 120 from FIG. 1) is removed from HPO-MBR 104b and transported to the anaerobic digester 112 at 392 kg COD/d and 34 kg N/d.

With continued reference to FIG. 3B, the algal-MPBR 108 intakes the effluent (partially treated wastewater), which mixes with microalgae disposed in one of a chamber, pond or other water receptacle exposed to light as described herein. The algal-MPBR 108 cultivates algal biomass as described herein, the microalgae takin N and P out of the effluent, as well as CO₂, the nutrients being concentrated as described herein by at least a membrane, like an ultrafiltration/microfiltration membrane. The algal biomass is then transported to the anaerobic digester 112 at 1,588 kg COD/d and 95 kg N/d (HPO-MBR). The anaerobic digester 112 digests the sludge solids utilizing the algal biomass transported therein. In some embodiments the algal biomass and sludge solids 120 are mixed mechanically. In some embodiments, paddles are used in a continuous rotation to agitate said sludge solid/algal biomass mixture. In some embodiments, a fluid jet is used to agitate the mixture. Anaerobic digester 112 exhausts effluent water at 528 kg COD/d and 86 kg N/d. In some embodiments, the effluent water is then stripped of ammonia (NH₃), the resultant effluent used as liquid fertilizer at 70 kg N/d. Additionally, the anaerobic digester 112 exhausts solid fertilizer (the remaining solids after digestion) at 478 kg COD/d and 43 kg N/d. Anaerobic digester 112 also captures and exhausts biogas 144 as a result of the digestion. The biomass may be vented to one or more other components to convert to other types of gas such as bio-methane and biofuel, as well as used in furnaces to generate electricity at 974 kg COD/d.

Referring now to FIG. 4, mass flow diagrams are depicted in block diagram form for both biological nutrient removal and MPBR embodiments. Referring first to the conventional BNR system, wastewater is provided to an ae-MBR 104 (hereinafter referred to using 104 again) at 1.9 ton COD/d. The ae-MBR 104 operates as described herein, separating sludge biomasses (sludge solids 120) to anaerobic digester 112 at 0.7 ton COD/d, in embodiments. The effluent from ae-MBR 104 is transported to BNR, wherein the biological material disposed therein is also provided oxygen at 0.7 ton O₂/d. The biological material nitrifying the effluent and absorbing carbon dioxide, the BNR then transporting the sludge biomass to anaerobic digester 112 at less than 0.1 ton COD/d.

Now referring to the MPBR embodiment, wastewater is provided to the ae-MBR 104 at the same 1.9 ton COD/d. The ae-MBR 104 effluent is provided to MPBR, which operates as the algal-MPBR 108 described herein above by concentrating the nutrients that are removed from the effluent by microalgae exposed to light and provided with CO₂, shown herein as CO₂ fixation of 1.3 ton COD/d. The MPBR cultivates algal biomass which is then transported to anaerobic digester 112.

Referring now to FIG. 5, a plot that illustrates the relationship between F/M ratio and the oxygen transfer requirement for various MLVSSs. This graph indicates that there is a limiting F/M ratio for each mixed liquor suspended solids concentration, above which the oxygen demand requirements cannot be satisfied by conventional aeration method. For example, F/M ratio must be maintained below 0.15 kg BOD/kg MLVSS/day when the operating MLVSS is 6,000 mg/L in order that the oxygen demand does not exceed the conventional aeration capability. However, under the condition of the use of pure oxygen, its aeration capability can cover F/M ratio of 1.8 kg BOD/kg MLVSS/day, which is more than 10 times that of conventional aeration. Furthermore, the use of pure oxygen in MBR can maximize the nitrification. When treating high organic loading, the HPO aeration is capable to fully support MBRs to cover the nitrification because high oxygen transfer rate can satisfy the substantial oxygen demand required for the degradation of high content of organic matter and the nitrification of ammonia.

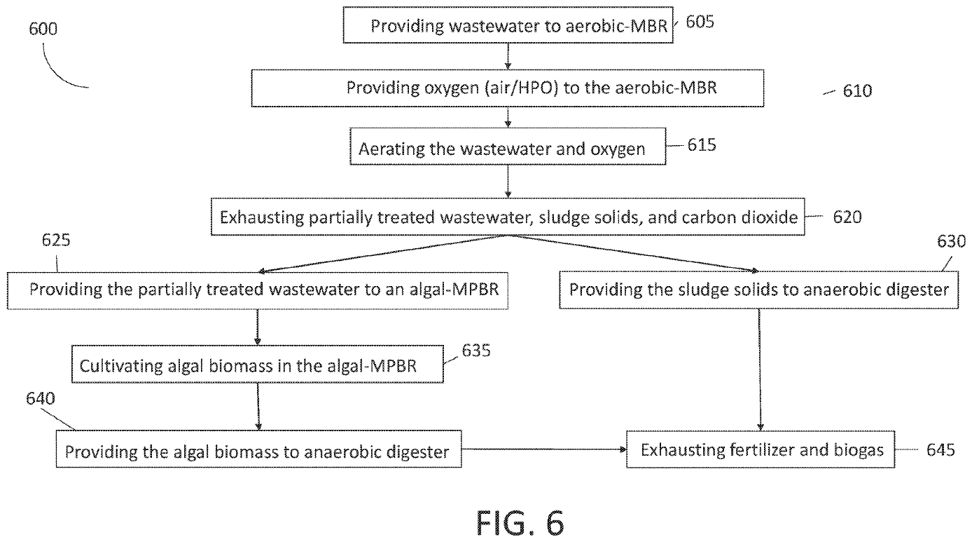

Referring now to FIG. 6, a method 600 for wastewater treatment is shown in flow diagram form. Method 600, at step 605, includes providing wastewater to an ae-MBR and/or HPO-MBR. Wastewater may be the same as wastewater 116. Wastewater 116 may be from a plurality of residential, commercial, or municipal sources, such as septic systems, sewers and/or storm drains. Ae-MBR/HPO-MBR 104 may be the same or similar to either of an aerobic or high purity oxygen membrane bioreactor as described herein.

Method 600, at step 610, includes providing normal air and/or pure oxygen to the ae-MBR/HPO-MBR. Herein, use of pure oxygen can significantly advance the oxygen transfer rate and finally organic loading rate. Aeration with pure oxygen provides higher gas phase oxygen concentrations than normal air systems and increases the oxygen mass transfer driving force, allowing faster treatment rates with higher mixed liquor suspended solids (MLVSS). The use of high purity of oxygen can achieve high F/M ratio as well as the high oxygen transfer efficiency, which are needed to treat high COD loading wastewater without depleting the dissolved oxygen in bioreactor. Ae-MBR/HPO-MBR 104 may include a plurality of distinct chambers in fluid communication with each other. For example, influent wastewater such as wastewater 116 may flow or be pumped into a first chamber comprising an aerator, such as a surface aerator 204 in FIG. 2.

Method 600, at step 615, includes aerating the influent wastewater, thereby incorporating the normal air/pure oxygen into the wastewater. In some embodiments, the ae-MBR/HPO-MBR is a staged ae-MBR/HPO-MBR, wherein each stage, such as a first and second stage include a surface aerator. Each stage of the ae-MBR/HPO-MBR may be in fluid communication with one another, each successive stage of the aeration process further clarifying the influent wastewater. For example, influent wastewater such as wastewater 116 may flow or be pumped into a first chamber of the ae-MBR/HPO-MBR 104, which includes an aerator, such as a surface aerator 204 in FIG. 2.

Method 600, at step 620, includes exhausting output effluent, the output effluent including partially treated wastewater and dissolved carbon dioxide, sludge solids and off-gas carbon dioxide. The carbon dioxide and the partially treated wastewater are vented, piped, or otherwise transported to the membrane photo bioreactor (algal-MPBR) 108.

Method 600, at step 625, includes providing the partially treated wastewater to the algal-MPBR 108. This partially treated wastewater may permeate the final membrane in the ae-MBR/HPO-MBR 104 and comprise N and P, as well as dissolved CO₂, including but not limited to, the same amount of CO₂ as found in an equal volume of air. In some embodiments, the effluent partially treated wastewater from ae-MBR/HPO-MBR 104 may include over 20% dissolved CO₂ suspended therein.

The method 600, at step 630 includes providing the sludge solids to the anaerobic digester. One of skill in the art would appreciate that steps 625 and 630 may occur simultaneously or in opposite order. Steps 625 and 630 may occur continuously, in phases, stages, or steps. The UF component 212 is configured to separate and exhaust sludge solids 120, partially treated water (which may contain dissolved carbon dioxide (CO₂), and gaseous components, herein referred to off-gas, which contains gaseous CO₂ 124.

The method 600, at step 635, includes cultivating algal biomass in the algal-MPBR. The algal-MPBR may be configured to capture the dissolved and gaseous carbon dioxide. The algal-MPBR includes microalgae disposed in at least a chamber where the wastewater is allowed to flow into and contain therein. The algal-MPBR includes at least at least an opening for light to enter said algal-MPBR. The algal-MPBR may include one or more openings, mirrors, lens, and/or a combination thereof to allow natural light such as sunlight to enter said algal-MPBR. The algal-MPBR may include artificial light sources configured to provide light to said algal-MPBR, such as lightbulbs, LED arrays, or the like, as described herein. The algal-MPBR includes at least one immersed ultrafiltration/microfiltration (UF/MF) membrane. Said algal-MPBR membrane is configured to concentrate nutrients from the influent partially treated wastewater via the UF/MF membrane. The nutrients are absorbed and eaten by the microalgae disposed therein.

Method 600, at step 640, includes providing the sludge solids to the anaerobic digester. The sludge solids are piped into the sludge anaerobic digester which may be formed as a single tank or a series of tanks in fluid communication together. Anaerobic digester 112 may be configured to intake sludge solids 120 from ae-MBR/HPO-MBR 104. The sludge solids 120 may be agitated by a mixer, jets, or other mechanical or fluid agitator configured to mix said sludge solids with algal biomass 128. Anaerobic digester 112 may be configured to capture biogas 144 produced from the digestion of the particulates in the sludge by the algal biomass, the algal biomass 128 containing, in some embodiments, large amounts of CO₂ from the algal-MPBR 108. Anaerobic digester 112 may be configured to capture biogas 144 in one or more portions of the tank digestion takes place, or one or distinct chambers or tanks. For example, biogas 144 may rise from the liquid disposed in a lower portion of the anaerobic digester 112 and out a vent such as a pipe, duct, or other pathway to one or more downstream components. Anaerobic digester 112 may be a net energy producer, compensating from about 25~50% of energy needs by using the produced biogas 144 from the anaerobic digester 112.

Method 600, at step 645, includes exhausting fertilizer and biogas. The fertilizer may be liquid fertilizer and/or solid fertilizer. In some embodiments, the liquid fertilizer may be subject to ammonia stripping, wherein excess NH₃ is stripped from said liquid. In some embodiments, the liquid fertilizer may be passed through one or more UF membranes, the membranes configured to remove lasting particles in the liquid, which may then be used as indirect potable water, such as in irrigation. Step 645 also includes exhausting biogas. This may include capturing biogas generated during the anaerobic digestion process, such as in a portion of the digester tank, a separate tank disposed therein, or one or more altogether separate and distinct tanks. Biogas may be vented, piped, or transported to one or more other components configured to capture, process, utilize, or burn said biogas. For example and without limitation, biogas generated from digestion may be processed and converted to bio-methane, the production of which can be seen in FIG. 8. In some embodiments, the biogas is utilized to generate hydrogen gas (H₂). In some embodiments, the biogas is utilized to generate biofuel. In some embodiments, the biogas is utilized to generate electricity, such as through burning in a steam-powered generator.

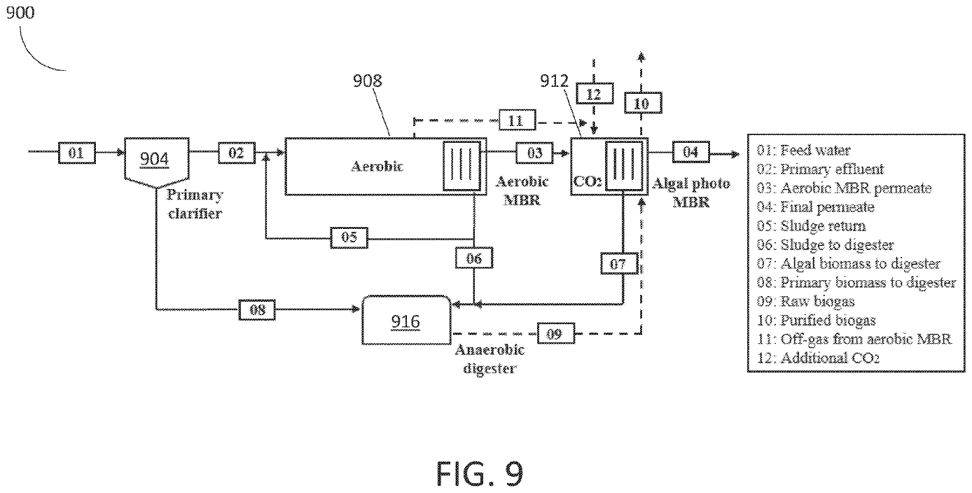

Referring now to FIG. 9, an embodiment of a wastewater treatment system 900 is shown in schematic diagram view. System 900 includes primary clarifier 904 configured to clarify the influent wastewater (feed water 01) prior to entering the aerobic-MBR 908. Clarifying feed water 01 includes removing heavier solids before biological treatment process. Primary clarifier 904 may be configured for sedimentation, wherein suspended solids, oil, and grease are removed prior to biological treatment by the MBR. Sludge is settled to the bottom of the clarifier basins and collected and removed by a sludge removal system, the sludge herein labeled as primary biomass to digester 916. Meanwhile, oil and grease float to the surface and may be manually or automatedly skimmed off. In embodiments, primary clarifier 904 may remove about 60 percent of suspended solids and 30 to 40 percent of Biological Oxygen Demand (BOD). Primary clarifier 904 is configured to output primary effluent 02 to the ae-MBR 908, as described herein below. Primary effluent 02 may have a portion of suspended solids removed, but still contain dissolved nitrogen, phosphorous and carbon dioxide, among other compounds and elements.

System 900 includes the three main components as discussed in reference to FIGS. 1 and 2. System 900 includes a staged ae-MBR 908 configured to separate sludge solids from partially treated wastewater, as well as off-gas carbon dioxide for further use by other components in the system. System 900 includes an algal photo MBR 912 configured to cultivate algal biomass using seeded microalgae and nutrients absorbed from the partially treated wastewater, in this diagram labeled aerobic MBR permeate 03. The difference between a traditional wastewater treatment is system is the traditional BNR process is replaced by the algal photo MBR (similar or the same as algal-MPBR 108), where microalgae remove N and P to form algal biomass with higher carbon content. Algal photo MBR 912 is configured to cultivate the algal biomass 07 as well as filter the wastewater treated therein, exhausting said water as final permeate 04. Final permeate 04 may be potable drinking water as described in reference to FIG. 1, reuse water 140.

System 900 includes an anaerobic digester 916, as described in reference to FIG. 1. Anaerobic digester 916 is configured to process the biomass (primary biomass 08, secondary biomass 06, and algal biomass 07, respectively) generated in each process and produce raw digester biogas 09 (methane, CO₂, and other gases).

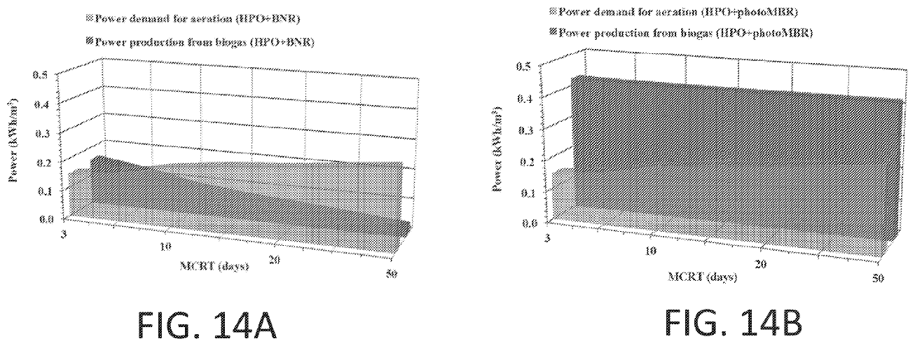

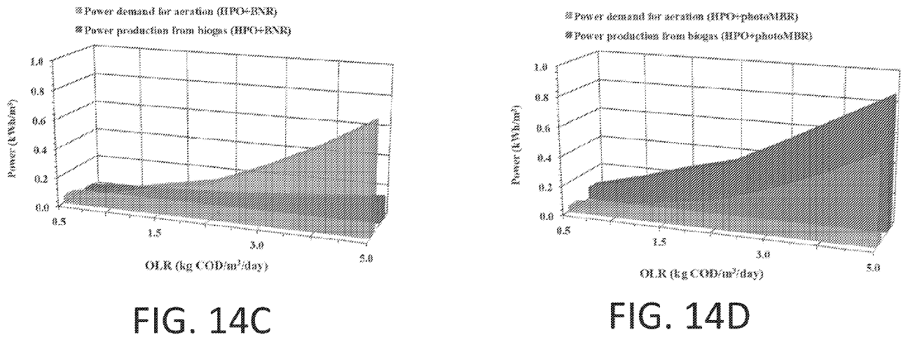

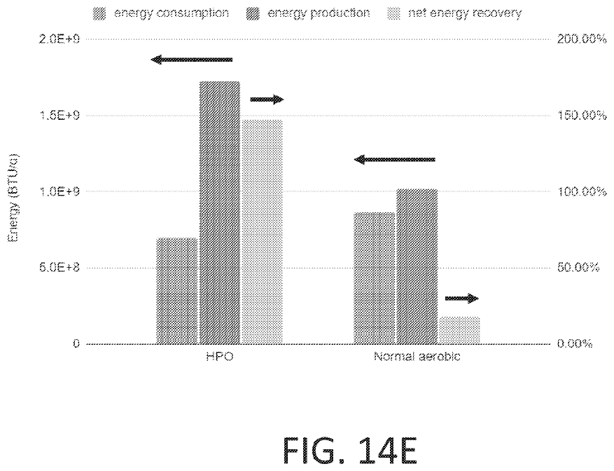

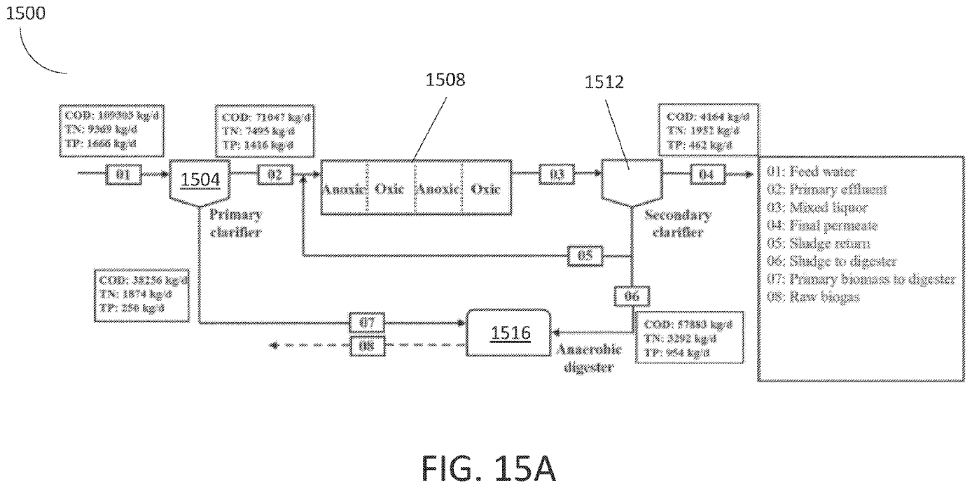

With continued reference to FIG. 9, algal photo MBR 912 is configured to also be used as a biogas scrubbing tank to purify the raw digester biogas 09 produced in anaerobic digester 916. CO₂ and other gases were absorbed and digested in the algal photo MBR, thereby greatly increasing the algal biomass production and the proportion of methane in the biogas, the contents of which may be seen in the charts presented herein as FIG. 13A-C. The biogas produced by system 900 (and system 100) can be converted to other types of energy such as bio-methane and electricity, in embodiments. The power demand of the system may be less than the power created by said biogas when utilized an algal photo MBR (as system 100 and 900) do over the conventional methods of BNR. The difference in energy demand versus potential energy production from the biogas within the system can be seen in FIGS. 14A-D. FIGS. 14A and 14C, specifically show three-dimensional plots overlaid on each other of power demand for aeration and power production from biogas over a range of MCRT and OLR, respectively. Similarly, FIGS. 14B and 14C show the power demand of aeration versus the power production from biogas for the aeration and algal photo MBR system as described herein for a range of MCRT and OLR. These plots further demonstrate how the power production outweighs the power demand only for the aeration and algal photo MBR system, systems similar to 100 and 900.

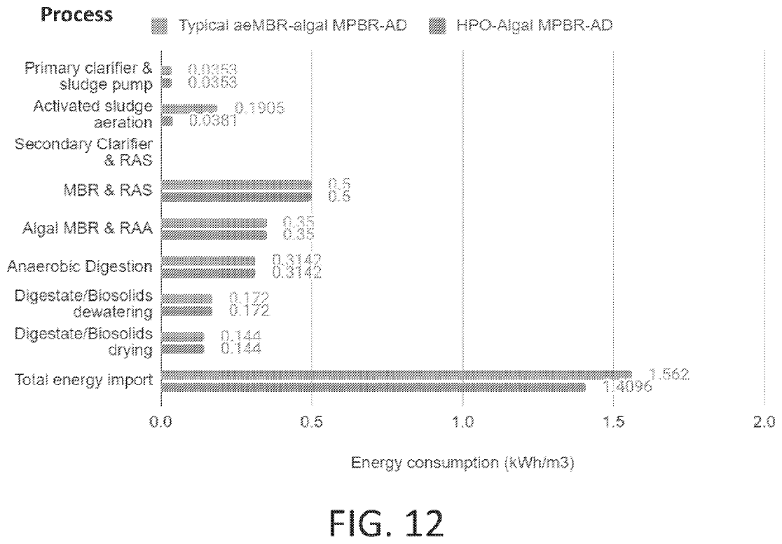

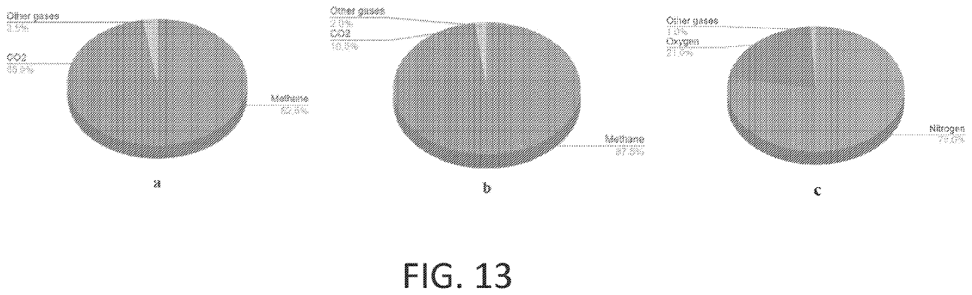

Referring now to FIG. 12, a plot that illustrates the energy consumption for each process in system 900 is shown in bar graph form. The plot shown energy consumption in kWh/m 3 of various components present in an exemplary system similar to system 900, which includes the four main components as discussed (a primary clarifier 904, a staged aerobic-MBR 908, an algal photo MBR 912, and an anaerobic digester 916). This graph indicates that the energy consumption of primary clarifier is 0.0353 kWh per cubic meter wastewater. An ae-MBR (104a from FIG. 3A) consumes 0.6905 kWh per cubic meter wastewater. However, under the situation of a staged HPO-MBR (104b from FIG. 3B), use high purity oxygen can significantly advance the oxygen transfer rate and reduce the amount of aeration gas because the oxygen content of normal air is only 20% (FIG. 13C). By using pure oxygen in the aeration process, energy consumption of HPO-MBR 104b can be reduced to 0.5381 kWh per cubic meter wastewater. The algal-MPBR 912 may include artificial light sources configured to provide light to said algal-MPBR, such as lightbulbs, LED arrays, or the like, as described herein, which consumes 0.35 kWh per cubic meter wastewater. The energy demand of an anaerobic digester 916 in system 900 is 0.6302 kWh/m³. The total energy input of the HPO-MBR 104b-algalMPBR system is 1.4096 kWh/m³, whereas the total energy import of the ae-MBR 104a-algal MPBR system is 1.562 kWh/m³. Thus the total energy import is lower for a system utilizing a high purity oxygen MBR as described herein.

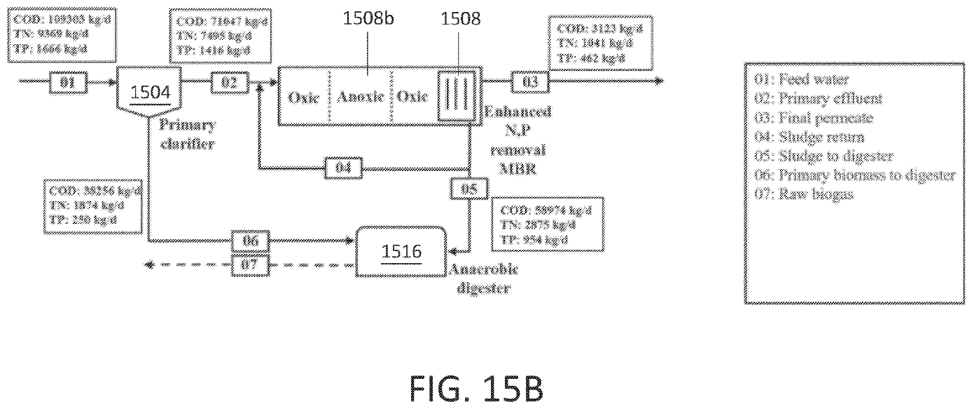

Referring now to FIG. 14E, a plot that illustrates the energy demand, energy production, and energy recovery for system 900 is shown in bar graph form. If we ignore the cost of making pure oxygen, a system such as system 900 with an HPO-MBR will consume less energy than a similar system with an ae-MBR (698,276,726 BTU/d vs. 862,070,032 BTU/d). In addition, using pure oxygen can significantly advance the oxygen transfer rate and finally organic loading rate. Therefore, the system like system 900 with an HPO-MBR can generate more biogas than the system 900 with an ae-MBR (×1.7). Taking all factors into consideration, net energy recovery of system 900 with an HPO-MBR is much greater than that of system 900 with an ae-MBR (148% vs. 18%) as can be seen from the right-hand bar of each graph in FIG. 15.

### Embodiments of the Systems and Methods

Biological wastewater treatment models are generally classified as a steady state model or an unsteady state model. Steady state models derive the relationship between microbial growth rate and mean cell retention time (MCRT) from steady-state mass balance for cells and their substrates. These models enable the simulator to predict the effluent substrate concentration very readily, biomass yield and oxygen requirement by function of MCRT. Unsteady state models had been developed for the purpose of process dynamic control since steady state models are limited to perform dynamic simulation with time-dependent variable inputs. Despite their high accuracy of predicting dynamic effects of time-dependent variable inputs, the unsteady-state models require not merely high technics to develop the simulation but more complexity to complete the calibration of model parameters. Final purpose of the simulation of these embodiments is to evaluate the performances and energy-benefits of SWR3 under various effluent water quality and operating conditions. Even though this method will cover the biological effects of the operating factors such as the nutrient loading rate, the dynamic process control is not one of major intention of this method. Therefore, one of steady-state models was selected to develop the WWTP simulation in this method as described in the following sections.

In various embodiments, a system for wastewater treatment 1500 is shown in FIG. 15A-15B. The system may include modifying system 900 via integrating the BNR process with the CAS process. In addition, the ability to model both bacteria-based and algae-based MBRs using various biological conversion factors and process parameters extracted are as described below. All scenarios discussed herein, in relation to systems 1500, may use simulated 208,197 m3/d (55 MGD) of wastewater influent. The three different process scenarios are illustrated in FIGS. 15A-15B. In the first scenario, a BNR process is used to remove N and P and a CAS process is employed to remove dissolved organic carbon. A traditional secondary clarifier 1512 can separate settleable biological flocs from the aqueous stream by sedimentation to obtain secondary clarified effluent. Tertiary treatment via microfiltration can be used after secondary treatment to provide the same level of suspended solids removal as the MBR-based scenarios (FIG. 15A).

In another embodiment, shown in FIG. 15B, the CAS-BNR process can be replaced by an aerobic MBR 1508 with BNR. The immersed microfiltration membrane at the end of the MBR makes SS negligible (<1 mg/L) and typically BOD <5 ppm, which when combined with the upfront anaerobic/anoxic BNR reactors 1508b can deliver exceptional quality effluent 03 in a much smaller footprint.

In another embodiment, which was shown in FIG. 9, an aerobic MBR 908 targets dissolved organic carbon removal without BNR by limiting the SRT to 5 days, while the traditional BNR process is replaced by an algal-MPBR 912, where microalgae remove N and P to form algal biomass with higher carbon content. The primary clarifier 904/1504 was used in all three scenarios to remove heavier solids before biological treatment process. Anaerobic digester 916/1516 was used in all three scenarios to process the biomass (primary biomass, secondary biomass, and algal biomass, respectively) generated in each process and produce digester biogas (methane, CO₂, and other gases). In addition, algal-MPBR 912 can also used as a biogas scrubbing tank to purify the raw digester biogas produced in anaerobic digester. CO₂ and other gases can be absorbed and digested in the algal-MPBR 912, thereby greatly increasing the algal biomass production and the proportion of methane in the biogas.

### Primary Treatment

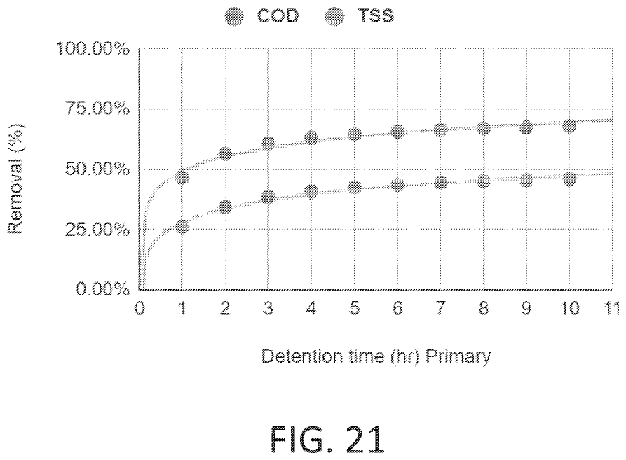

In various embodiments, primary treatment can precipitate over 40% of the organic pollutants in the wastewater, aggregate to form primary sludge, and be advanced treated in anaerobic digester to produce raw biogas. At the steady state, the relationship between primary detention time and pollutants removal efficiency is

$$R = \frac{t}{a + bt} \qquad ( 1 )$$

Where R is removal efficiency of BOD/TSS, t is primary detention time, a and b are empirical numbers. Eqn (1) reveals that the removal efficiency of BOD and TSS will increase with the increase of primary detention time. According to the simulation, at least 2 hours of detention time is required to achieve a stable removal efficiency for both BOD and TSS (55% and 30%, respectively) (FIG. 21). This method applied 2 hours detention time, which provides 55% BOD removal and 30% TSS removal during the primary treatment process.

This method applied typical values of key parameters as shown in Table 1 and varied MCRT (θ_{C}) of aeMBR to investigate the change of F/M ratio. At the steady state, a general relationship between MCRT and F/M is

$$\frac{Food}{Microorganism} = \frac{Q \text{?} ( \text{?} - S )}{X \text{?} V} = \frac{μ}{Y} \qquad ( 2 )$$

$$\text{?} \text{indicates text missing or illegible when filed}$$

where Q is influent flow rate, X is concentration of microbial cells, Y is yield of microbial sludge per unit mass of removed substrate, K_{D} is specific microorganism decay rate, μ is specific microorganism growth rate, S_{O} is influent substrate concentration, and S effluent substrate concentration. If μ in Eqn (1) is replaced with μ−K_{D}=1/θ_{C},

$$\frac{Food}{Microorganism} = \frac{1}{γ} ( {K}_{D} + \frac{1}{{θ}_{C}} ) \qquad ( 3 )$$

where KD is cell decay rate and 9 is mean cell retention time (MCRT). Eqn (3) reveals that MCRT can control F/M ratio in aeMBR at the steady state if KD and Y keep constant and that longer MCRT can reduce F/M ratio. As Eqn (3) predicts, the simulation with the model of Lawrence and McCarty demonstrated that the F/M ratio decreased with MCRT since microorganism concentration in aeMBR (i.e., MLVSS) was multiplied as MCRT increased (FIG. S3). Typical values of F/M ratio in CAS process range from 0.15 to 0.70 kg COD/kg MLVSS/day and, generally, operators of CAS processes run a low value of F/M ratio to prevent (1) thick foaming problem in bioreactor, (2) DO deficiency under 2 mg/L, and (3) the growth of filamentous bacteria in bioreactors, which seriously deteriorate the settling ability of sludge in clarifier and effluent water quality. MBR process can control MCRT readily without any clarifiers because the membrane system rejects >99% of MLVSS, which retains it in bioreactor. While the average DO concentration is approximately 0.5 to 3.0 mg/L for CAS process, that of aerobic process is known 1 to 4 mg/L.

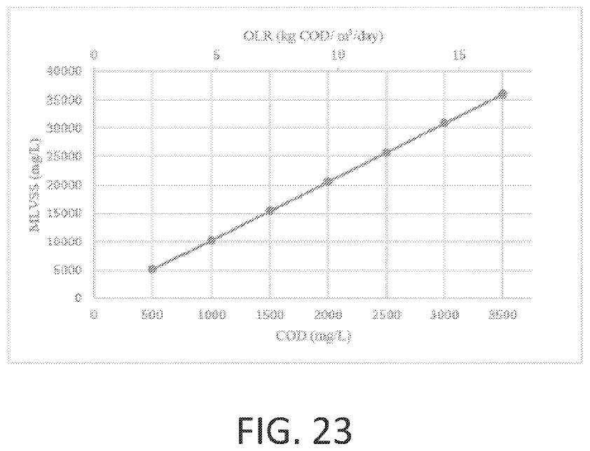

According to various embodiments of the systems and methods disclosed herein, at least 15 days of MCRT is required to achieve a stable F/M ratio (0.15-0.25 g COD/g MLVSS/day). This method applied 0.2 g COD/g MLVSS/day of F/M ratio, which needs 20 days of MCRT. Although they also change dynamically with organic loading rate (OLR) in the real world, this simulation assumed constant microbial activities (i.e., KD, Y) with different OLR to avoid a complex modeling. FIG. 23 shows that MLVSS grows proportionally with increase in OLR/COD. Even though it is true for higher biomass concentration in bioreactor to cover higher substrate loading rate, excessive microorganism contents cause a severe membrane fouling and a rising energy cost so that MBR processes typically run 8,000-12,000 mg MLVSS/L of biomass. In this simulation, the maximum OLR of satisfying the stable MLVSS (10,000 mg MLVSS/L) is 5 kg COD/m3/day.

TABLE 1
Model parameters for aeMBR

| Parameter | Value | | Description | Reference |
|---|---|---|---|---|
| S₀ | 344 | mg COD/L | Influent COD | [8, 43] |
| S₀_TN | 36 | mg TN/L | Influent Total Nitrogen | [8, 43] |
| S₀_P | 6.8 | mg P/L | Phosphorus as P | [8, 43] |
| [symbol] | 0.6 | g VSS/g VSS/day | Maximum growth rate | [43, 44] |
| K_{D} | 0.12 | g VSS/g VSS/day | Cell decay rate | [43] |
| [symbol] | 0.4 | g VSS/g COD | Aerobic biomass yield | [43, 44] |
| θ_{H} | 5 | Hours | Hydraulic retention time | [43] |
| θ_{C} | 20 | Days | Mean cell retention time | [8, 43] |
| [symbol] | 0.75 | g VSS/g VSS/day | Maximum growth rate | [43] |
| K_{D,PAOs} | 0.08 | g VSS/g VSS/day | Cell decay rate | [43] |
| Y_{aerobic,PAOs} | 0.12 | g VSS/g NH₄-N | Aerobic biomass yield | [43] |
| θ_{H,PAOs} | 1.3 | Hours | Hydraulic retention time | [43] |
| θ_{C,PAOs} | 15 | Days | Mean cell retention time | [43] |

| | | | |
|---|---|---|---|
| Cell formula* | C₅H₇NO₂ | Empirical cell formula | [43] |
| Cell formula** | C₂₀₀H₃₇₇O₁₀₃N₃₉P_{1.5} | Empirical cell formula | [45] |

*Typical aerobic bacteria;
**PAOs (Polyphosphate-accumulating organisms) [symbol]
indicates data missing or illegible when filed

In this method, a photo bioreactor can be seeded with algae to treat the permeate from aeMBR. In the algal-MPBR, the microalgae can fix CO₂ (g) from atmosphere as its carbon source. Therefore, a significant increase in the content of nutrients in the bioreactor will greatly promote the growth of algae, which will to a large extent increase the yield of algal biomass. The production rate of microalgae can be readily estimated with phosphorus loading rate, which is known to regulate the maximum growth rate of microalgae in photo-bioreactor. Algal biomass yield ranges from 20 g TSS/g P to 25 g TSS/g P and the value is dependent on total nutrient loading rate and substrate balance (C: N: P). Production rate of microalgae can be expressed as

$${P}_{algae} = {Y}_{algae} \cdot {Q}_{IN} \cdot {S}_{TP} \qquad ( 4 )$$

where is microalgae production rate (kg TSS/day), yield of microalgae per unit mass of influent nitrogen (g TSS/g N), influent volume rate (m³/day), and influent phosphorus concentration (mg N/L). Compared with conventional aerobic bioreactors, algal-MPBR can alleviate the greenhouse gas effect to a greater extent. Typical values of key parameters of the algal-MPBR are summarized in Table 2.

TABLE 2
Model parameters for apMBR.

| Parameter | Value | | Description | Reference |
|---|---|---|---|---|
| S₀ | 30 | mg COD/L | Influent COD | [8, 43] |
| S₀_TN | 22 | mg TN/L | Influent Total Nitrogen | [8, 43] |
| S₀_P | 3.5 | mg P/L | Phosphorus as P | [8, 43] |
| K_{D} | 0.12 | g VSS/g VSS/day | Cell decay rate | [43] |
| Y_{algae} | 0.4 | g VSS/g COD | Algal biomass yield | [43, 44] |
| Y_{algae} | 23 | g TSS/g P | Algal biomass yield | [43, 45] |
| θ_{C} | 25 | Days | Mean cell retention time | [8, 43] |
| CH₄ purifying | 25 | % | CH₄ purifying efficiency | [46, 47] |
| CO₂ capture | 71 | % | CO₂ capture efficiency | [46, 47] |

| | | | |
|---|---|---|---|
| Algae formula | C₁₀₀H₁₈₃O₄₈N₁₁P | Empirical cell formula | [43] |

### Model of Power Demand of Aeration for CAS and Aerobic MBR Processes

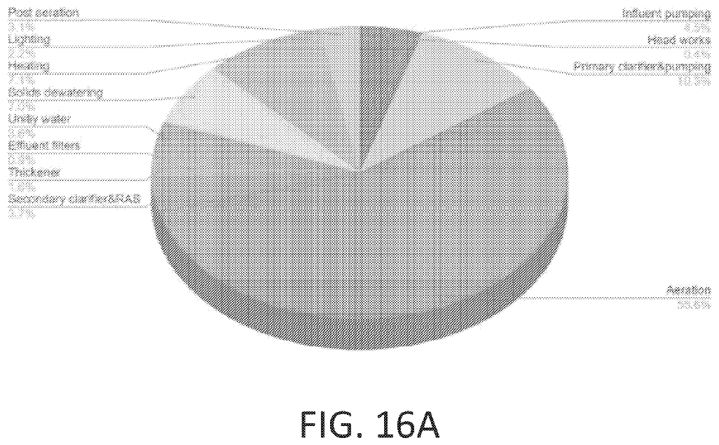

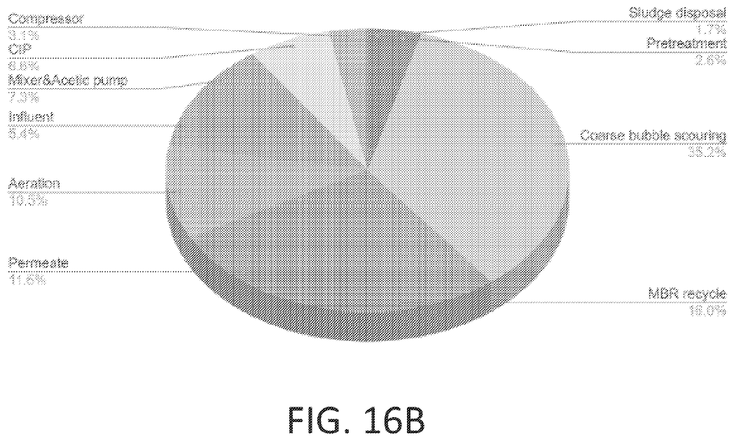

In CAS process, typical power requirements of processing 1,000 m³ of wastewater are about 1100 MJ to 2400 MJ, which are equivalent to 0.3 to 0.7 kWh/m³ of specific power demand. Majority of energy demand for typical WWTPs comes from the aeration for CAS process; it comprises over 55% of total energy demand in WWTP as shown in FIG. 16A. For conventional MBR process, aeration is not the most energy-consuming component, accounting for only ~10% of the total energy consumption. And coarse bubble scouring occupies more than 35% of the energy consumption, becoming the most energy-consuming part of the process (FIG. 16B). Therefore, the power demands of aeration of CAS process and aerobic MBR process are significant to compare the energy feasibilities of WWTP and SWR3.

To estimate the aeration energy demand, this method defined the total power demand of aeration as

$${P}_{Aeration} = \frac{OD}{AE} \qquad ( 5 )$$

Oxygen demand was calculated with the parameters given in Table 1. Aeration efficiency (AE) has a well-known relationship with standard aeration efficiency (AE) such as

$$AE = SAE \cdot α \cdot \text{?} \cdot ( \frac{β \text{?} - {C}_{L}}{\text{?}} ) \qquad ( 6 )$$

$$\text{?} \text{indicates text missing or illegible when filed}$$

where alpha is the ratio of mass transfer coefficient of the process to clean-water, beta the ratio of saturated DO (Cₛ) of the process to clean-water, and theta a correction factor accounting for effect of temperature on mass transfer rate (=1.024). This method assumed the ambient temperature (T−20° C.). CL is the average DO in bioreactor and typical values of CAS and MBR process are 2 mg O₂/L and 3 mg O₂/L, respectively. α is known to have a relationship with MLSS as [10, 45]

$$α = {e}^{- 0.08788 MLSS ( g / L )} \qquad ( 7 )$$

and commonly is 0.99 for municipal wastewater at TDS<1500 mg/L. The SAE is defined as

$$SAE = \frac{SOTR}{WP} \qquad ( 8 )$$

where SOTR stands for standard oxygen transfer rate (SOTR, kg O₂/h) and Wp for wired power (kW). Typical SAE of mechanical surface aerator is 3 lb O₂/hp/h (equivalent to 1.8 kg O₂/kW/h) for aeration using normal air. However, SAE is dependent on oxygen content in air phase because SOTR is proportional to the saturated DO (Cₛ) in liquid phase such as

$$SOTR = V \cdot {( \frac{{dC}_{L}}{dt} )}_{STD} = {K}_{La 20} \cdot \text{?} \cdot V \qquad ( 9 )$$

$$\text{?} \text{indicates text missing or illegible when filed}$$

where K_{La20} is clean water oxygen transfer coefficient at 20° C. (/h), C*_{s,20} surface saturation DO at 20° C., and V bioreactor volume (m³). Using Eqn (8) and Eqn (9), SAE of MBR process can be calculated as the below procedure

$$\frac{{SAE}_{MBR}}{{SAE}_{CAS}} = \frac{{SOTR}_{MBR}}{{SOTR}_{CAS}} = \frac{\text{?}}{\text{?}} ≅ \frac{\text{?}}{\text{?}} \qquad ( 10 )$$

$${SAE}_{MBR} ≅ {SAE}_{CAS} \cdot \frac{\text{?}}{\text{?}}$$

$$\text{?} \text{indicates text missing or illegible when filed}$$

Since C_{s,20}, MBR and C_{s,20}, CAS are 13.4 mg O₂/L and 9.08 mg O₂/L, respectively, SAE of MBR process is approximately 9.3 lb O₂/hp/h (equivalent to 6.7 kg O₂/kW/h).

### Anaerobic Digester

In this method, the biogas production rates rely on biodegraded biomass contents and methane yields per the decayed biomass like

$${P}_{Biogas} = {Y}_{Biogas} \cdot {Q}_{IN} \cdot {R}_{Biomass} \cdot {X}_{IN} \qquad ( 11 )$$

Where P_{biogas} production rate (m³ biogas/day), Ybiogas yield of biogas per unit mass of removed biomass (m³ biogas/kg VSS), Qin influent volume rate (m³/day), Rbiomass removal rate (%), Xin influent biomass concentration (mg VSS/L). Table 3 summarizes the modeling parameters used for the anaerobic digester.

The calculation of biogas (CH₄) purifying and CO₂ capture efficiency by the algal-MPBR were as follows:

$${CH}_{4} purifying ( \% ) = \frac{{E}_{{CH}_{4}} - {I}_{{CH}_{4}}}{{I}_{{CH}_{4}}} \times 100 \% \qquad ( 12 )$$

$${CO}_{2} capture efficiency ( \% ) = \frac{{I}_{{CO}_{2}} - {E}_{{CO}_{2}}}{{I}_{{CO}_{2}}} \times 100 \% \qquad ( 13 )$$

where E_{CH4} is purified effluent of CH₄ from algal-MPBR (m³ CH₄/day), I_{CH4} is influent raw biogas (m³ CH₄/day), E_{CO2} is final effluent of CO₂ from algal-MPBR (m³ CO₂/day), I_{CO2} is influent CO₂ from raw biogas (m³ CO₂/day). Typical values of key parameters of the algal-MPBR are summarized above in Table 2. Note in eq 12 the subtraction may be taken as an absolute value.

TABLE 3
Model parameters for anaerobic digester

| Parameter | Value | | Description | Reference |
|---|---|---|---|---|
| T | 53.5 | ° C. | Digester temp | [10, 48] |
| CH₄%_{algae} | 70 | % | Methane content | [10, 48] |
| CH₄%_{sludge} | 60 | % | Methane content | [10, 48] |
| CH₄%_{PAO} | 65 | % | Methane content | [10, 48] |
| Y_{algae} | 0.42 | L CH4/g | Biogas yield | [10, 48] |
| | | VSS | with algae | |
| Y_{sludge} | 0.37 | L CH4/g | Biogas yield | [10, 48] |
| | | VSS | with sludge | |
| Y_{PAO} | 0.32 | L CH4/g | Biogas yield | [10, 48] |
| | | VSS | with PAO | |
| R_{biomass} | 40 | % | Algal biomass yield | [45, 48] |
| θ_{H} | 6 | hours | Hydraulic | [45, 48] |
| | | | retention time | |
| θ_{C} | 30 | days | Solid retention time | [8, 48] |

### The Potential Net Energy of SWR3

To evaluate energy production from WWTPs and SWR3, this method compared three scenarios of WWTPs: (1) CAS followed by BNR, (2) aeMBR followed by BNR, and (3) aeMBR followed by algal-MPBR. Simulating calculation was used to convert the biogas production to power production in this method are presented in Eqn (14). More importantly, to make an embodiment of the method more accurate and objective, there are the following three detailed analyses of the energy consumption of each scenario according to different operating conditions: best practice, typical practice, and poor practice.

$${P}_{energy} = {P}_{totCH 4} \cdot {SC}_{CH 4} \cdot {UE}_{CH 4} \qquad ( 14 )$$

where P_{energy} is energy production rate (kWh/day), P_{totCH4} production of CH₄ (m³ CH₄/day), SC_{CH4} specific calories for CH₄, which is 9.8 kWh/m³ CH₄, UE_{CH4} utilization efficiency of CH₄, which is 70%.

One potential benefit of the SWR3 is its high quality of the final permeate, especially in the removal of N and P. The effluent of the algal-MPBR contains 2.5 mg/L total nitrogen, which is 4 mg/L and 5 mg/L lower than the first two scenarios under the standard condition, respectively. Algal permeate also contains 0.45 mg/L phosphorus, which is 0.55 mg/L lower than the first two scenarios. Furthermore, better water quality is also reflected in the lower COD content (15 mg/L), which is 15 mg/L and 15 mg/L lower than the first two scenarios, respectively (Table 4). Another potential benefit of the SWR3 is its high rate of CO₂ (g) sequestration. If there is no limit of supplying CO₂ (g) into apMBR, the microalgae system can capture 94,728 kg CO₂ (g)/day (about 78,288 kg COD/day), which is more than the CO₂ (g) emission from activated sludge process, which is 68,240 kg CO₂ (g)/day (FIG. S5 (c)). Based on the results of this model, we can not only fix all the off-gas from the aerobic MBR and convert them into biomass, but at the same time, we can also absorb an additional 26,488 kg CO₂ (g) from the atmosphere every day, thereby greatly increasing the production of biogas, and reduce the greenhouse effect. In this simulation, no demand of oxygen and external carbon compounds, enhanced biogas production and high rate of CO₂ (g) capture are shown to contribute to the high level of carbon-neutrality of SWR3. In the systems of FIGS. 9 and 15A-15B, the methods quantitatively analyzed the mass flows of carbon, nitrogen, and phosphorus compounds with the standard water quality for all three scenarios to demonstrate how the SWR3 makes better use of nutrients in the water, resulting in more biomass and a reduced greenhouse effect.

TABLE 4
Water quality throughout all three scenarios

| | | WQ | COD | TN | |
|---|---|---|---|---|---|
| Scenario | | standards | (mg/L) | (mg/L) | Phosphorus as P (mg/L) |
| Feed water | Primary treatment | | 525 | 45 | 8 |
| | effluent | | 344 | 36 | 6.8 |
| Scenario | CAS-BNR | Good | 25 | 5 | 0.5 |
| #1 | effivent | Standard | 30 | 7.5 | |
| | | Poor | 35 | 10 | 1.5 |
| Scenario | Primary treatment | | 344 | 36 | 6.8 |
| #2 | effluent | | | | |
| | MBR-BNR | Good | 20 | 4 | 0.5 |
| | effluent | Standard | 22.5 | 6.5 | |
| | | Poor | 25 | 9 | 1.5 |
| Scenario | Primary treatment | | 344 | 36 | 6.8 |
| #3 | effluent | | | | |
| | Aerobic MBR | | 40 | 22 | 4.5 |
| | effluent | | | | |
| | Photo algal MBR | Good | 12.5 | 1.5 | 0.1 |
| | effluent | Standard | 15 | 2.5 | 0.45 |
| | | Poor | 17.5 | 3.5 | 0.8 |

Note:
good, standard, and poor water quality were obtained from previous literatures and textbook [4, 5, 43].

### Biogas Production

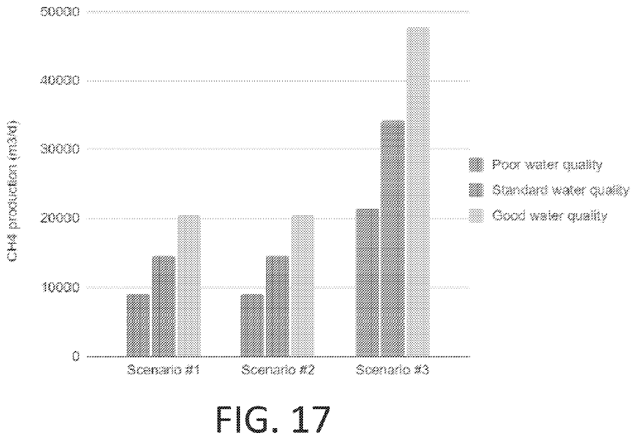

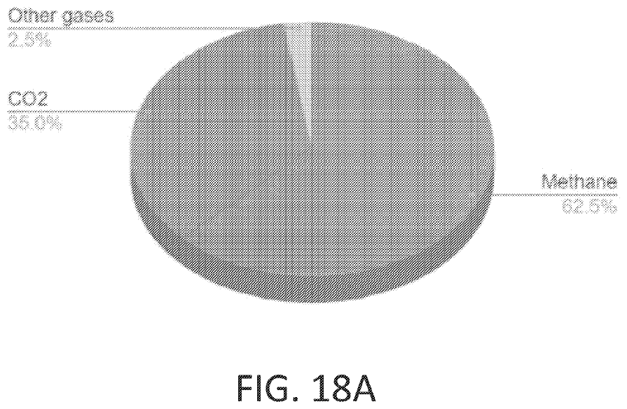

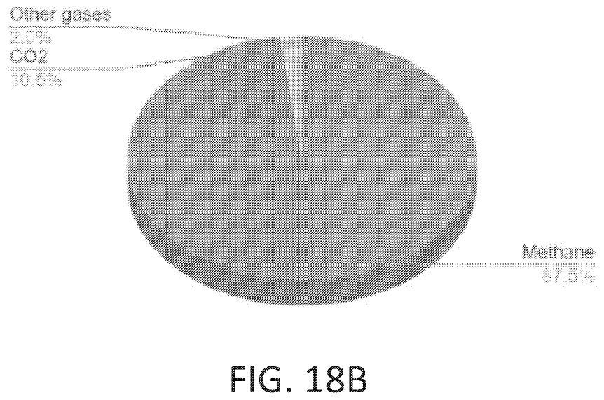

A simulation was performed to demonstrate the methane production from all three scenarios under different water quality conditions (FIG. 17). In all three embodiments of FIG. 9 and FIGS. 15A-15B, we found that as the quality of the effluent improved, the production of methane also increased. This can be explained as the higher quality of the effluent, the more dissolved organics and nutrients were converted into biomass by microorganisms, and then transferred to the AD to produce methane. In terms of methane production, there was no significant difference between CAS process and aeMBR, because the methane production in the first two scenarios was based on biomass produced by primary clarifier and aerobic bacteria. We fixed the parameters of the primary treatment and assumed that the bacteria behaved similarly in all the scenes, so the yields of primary biomass and bacterial biomass were almost fixed. However, in the SWR3 model, we introduced microalgae, which can efficiently convert nutrients and fixed carbon sources to the high carbon content algal biomass, which greatly increases methane production compared to the previous two scenarios, from 15,000 m³/d to 28,000 m³/d, under the standard condition. Additionally, the algal-MPBR was also used to purify the raw digester biogas produced in the AD. CO₂ and other gases were absorbed and digested in the algal-MPBR, thereby greatly increasing the algal biomass production and the proportion of methane in the biogas, from 28,000 m³/d to 35,000 m³/d, under the standard condition.

### SWR3 as a Net Energy Producer

Average energy demands for municipal WWTPs of employing CAS and anaerobic sludge digestion are 0.3~0.7 kWh/m³ of treated wastewater and about 50% of them arises to supply air to aerobic basin. In contrast to aerobic digestion, anaerobic sludge digestion is an energy producer and can compensate 25~50% of energy needs by using the produced biogas from AD. Therefore, with enhanced biogas production in the AD, a WWTP approaches closer to a net energy producer. Algal-MPBR has a great potential of altering COD mass flow in a WWTP by sequestering a large amount of CO₂ in algal biomass during nutrient removal. This extensive fixation of CO₂ in algal biomass is equal to excessive conversion of CO₂ to organic sources, with which anaerobic digestion can harvest a considerable bioenergy and satisfy more portions of energy needs in WWTPs. In this method, the unit of energy is converted from the commonly used PE, kWh/m³ treated water, to BTU value, so that it can be compared directly with the energy calorific value generated by the biogas.

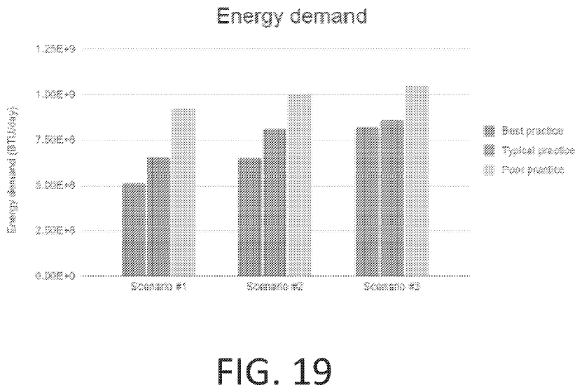

In various embodiments, there can be three major variables directly related to the energy demand and production: (1) operating conditions, (2) the composition of the secondary treatment process, and (3) water quality of the permeate. With fixed processing units, energy demand of the system increases with the harsh operating conditions, from 5.1×108 BTU to 9.1×108 BTU (FIG. 15A), 6.6×108 BTU to 1.0×109 BTU (FIG. 15B), and 8.1×108 BTU to 1.1×109 BTU (FIG. 9). In addition, energy demand also increases with as the number of MBRs increases under the same operating conditions because the scouring and filtration processes are quite energy intensive compared with the CAS process (FIG. 19).

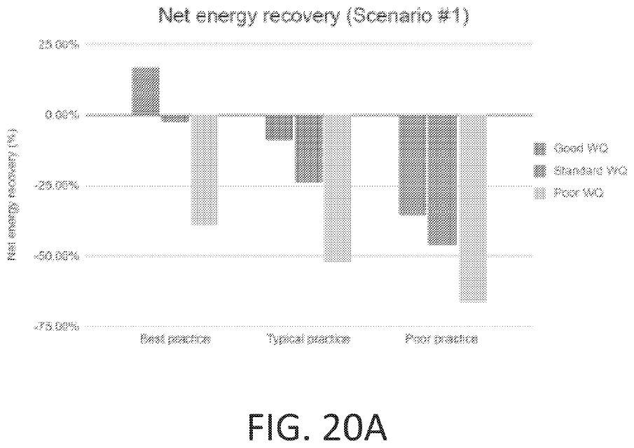

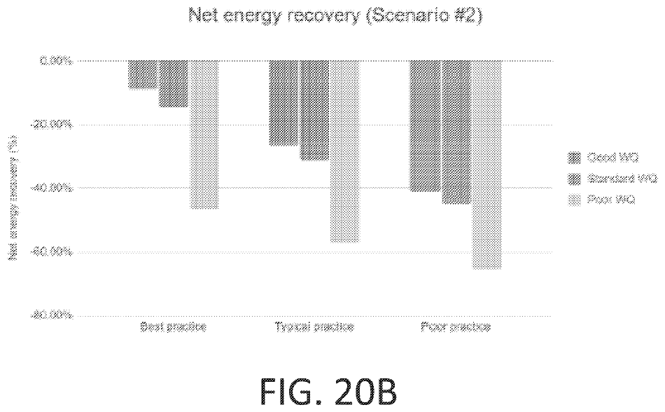

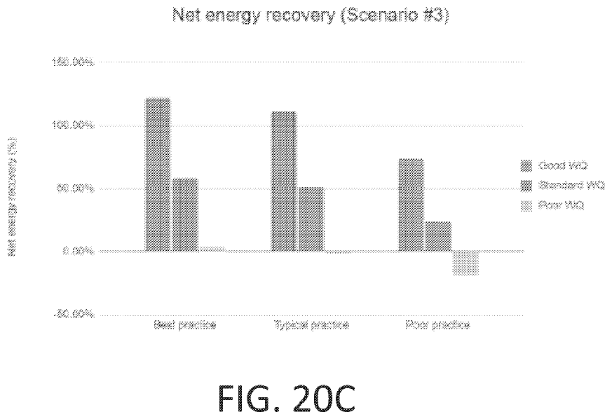

Furthermore, as mentioned in the previous paragraph, the production of biomass will increase with the improvement of effluent water quality, thereby increasing the production of biogas, and ultimately increasing the production of energy. FIGS. 20A-20C illustrated that for the first two scenarios, becoming an energy positive center is more demanding. For the traditional CAS process, only by achieving high-quality effluent and an optimized operating condition at the same time can it be possible to achieve an energy recovery rate over 117%. As for the aerobic MBR process in the second scenario, the conditions are more stringent because the aerobic MBR consumes more energy than CAS. According to the results of the simulation, there is no way to achieve energy positive in the second scenario. However, for the SWR3, as long as the water quality of the permeate is up to standard (standard or better), regardless of the operation of the entire system, the energy provided by biogas can cover the total energy consumption, or even better (net energy recovery rate over 120%), which strongly demonstrated that our novel SWR3 system had the great potential to convert wastewater treatment process from an energy cost-center to a profit-center.

### Aerobic Biological Treatment

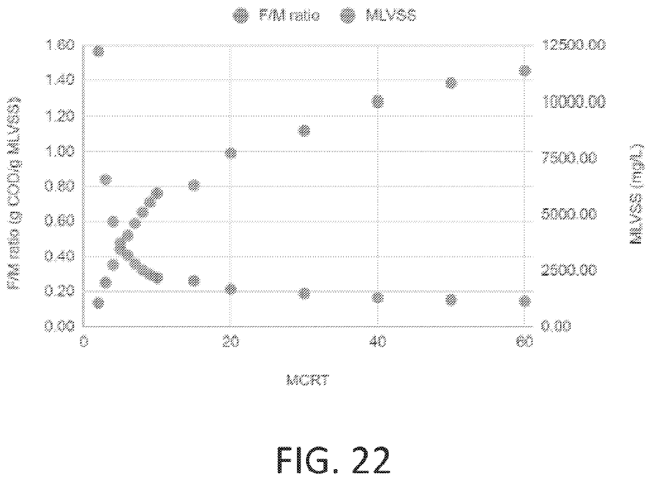

This method developed sub-models of four major sub-processes (the primary treatment process, activated sludge process, nutrient removal process and anaerobic digestion) in WWTPs. Table S1 presents the modeling parameters that this method adopted for simulation. FIG. 21 illustrates the relationship of primary detention time with COD/TSS removal efficiency, FIG. 22 illustrates the relationship of MCRT with MLVSS and F/M ratio, and FIG. 23 illustrates the relationship between MLVSS and OLR/COD.

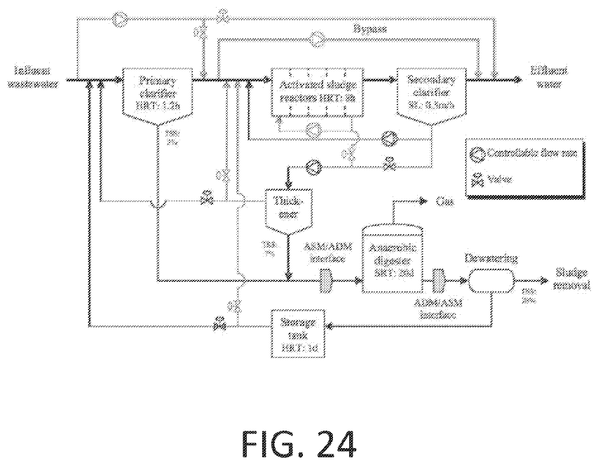

In various embodiments, a general WWTP model may be employed as shown in FIG. 24. Since this protocol excludes the biological or chemical nutrient removal, various embodiments can modify the protocol by adding the nutrient process following the activated sludge process. As explained in the above section various embodiments of a steady-state model can be deployed to develop a simulator that aims to compare the performances of the existing WWTP protocol and various embodiments, of the systems and methods disclosed herein, since the more complicated models such as structured models are not necessary. For example and without limitation, a unified approach that builds a steady-state material balances of microorganism and substrate with Monod kinetics. This model derived the correlation between MCRT and microorganism growth rate from the microorganism balance.

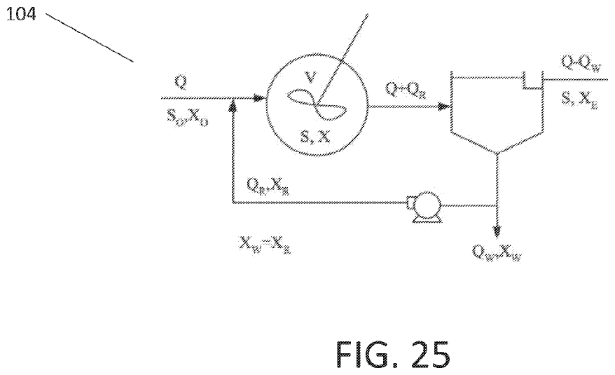

Based on the typical configuration of activated sludge process (ASP) as shown in FIG. 25, mass balances of microbial cells (X) and substrate(S) can be established as

$$For cells ( x ) : V \frac{dX}{dt} = {QX}_{0} - ( Q - {Q}_{W} ) \text{?} - {Q}_{W} {X}_{W} + ( μ - {K}_{D} ) XV \qquad ( 1 )$$

$$For substrate ( S ) : V \frac{\text{?}}{dt} = {QS}_{0} - ( Q - {Q}_{W} ) S - {Q}_{W} {S}_{W} - \text{?} XV \qquad ( 2 )$$

$$\text{?} \text{indicates text missing or illegible when filed}$$

where V is bioreactor volume, Q influent flow rate, Q_{W} waste sludge flow rate, Q_{R} return sludge flow rate, Y yield of microbial sludge per unit mass of removed substrate, K_{D} specific microorganism decay rate, μ specific microorganism growth rate, and S effluent substrate concentration.

At steady state, assumptions of completely mixed reactor and no microorganisms in the waste influent (X₀~0) give the mass balances of

$$Cells ( x ) : 0 = {QX}_{0} - ( Q - {Q}_{W} ) \text{?} - {Q}_{W} {X}_{W} + ( μ - \text{?} ) XV \qquad ( 3 )$$

$$μ - \text{?} = \frac{{Q}_{W} {X}_{W}}{XV}$$

$$\text{?} \text{indicates text missing or illegible when filed}$$

$$Substrate ( S ) : 0 = {QS}_{0} - ( Q - {Q}_{W} ) S - {Q}_{W} {S}_{W} - \frac{μ}{Y} XV \qquad ( 4 )$$

$$μ \frac{X}{Y} = \frac{Q}{V} ( {S}_{0} - S )$$

MCRT (θ_{C}) is defined as

$${θ}_{C} = \frac{XV}{{Q}_{W} {X}_{W}} \qquad ( 5 )$$

Integration of Eqn (3) and Eqn (5) provides

$$μ - {K}_{D} = \frac{1}{{θ}_{C}} \qquad ( 6 )$$

μ in Eqn (4) can be substituted with Eqn (6) as

$$X = \frac{YQ {θ}_{C} ( \text{?} - \text{?} )}{V ( \text{?} {θ}_{C} + 1 )} \qquad ( 7 )$$

$$\text{?} \text{indicates text missing or illegible when filed}$$

Equation of Monod kinetics is

$$μ = \frac{\text{?}}{\text{?}} \qquad ( 8 )$$

$$\text{?} \text{indicates text missing or illegible when filed}$$

where μₘₐₓ is maximum specific microorganism growth rate and Ks is half saturation constant. Lawrence and McCarty added Eqn (8) in Eqn (6) and derived a relationship between substrate concentration (S) and MCRT (θ_{C}) as

$$S = \frac{\text{?} ( 1 + {θ}_{C} {K}_{D} )}{{θ}_{C} ( \text{?} - {K}_{D} ) - 1} \qquad ( 9 )$$

$$\text{?} \text{indicates text missing or illegible when filed}$$

Based on this simple steady-state model, this method developed sub-models of three major subprocesses (the activated sludge process, nutrient removal process and anaerobic digestion) in WWTPs and integrated them to estimate the benefits of SWR3 and compare them with the conventional WWTP equipped with a conventional BNR process. We focused on only those subprocesses while neglecting the other processes like primary clarification, gravity thickening, dewatering and sludge deposal. To neglect the nitrification through ASP and to maximize the loading rates of organic substrates and nutrients, we assumed that aeration for ASP applies high purity oxygen. Table 1 below presents the modeling parameters that this method adopted for simulation.

The herein disclosed methods for algal-MPBR and AnMBR are based on biomass yield with nutrient loading rate and biogas yield with organic loading rate, respectively. For algal-MPBR, the production rate of micro-algae can be readily estimated with nitrogen loading rate, which is known to regulate the maximum growth rate of microalgae in photo-bioreactor. Algal biomass yield ranges from 5 g TSS/g N to 12 g TSS/g N and the value is dependent on total nutrient loading rate and substrate balance (C: N: P). Production rate of microalgae can be expressed as

$${P}_{MA} = {Y}_{MA} \cdot \text{?} \cdot {S}_{N} \qquad ( 10 )$$

$$\text{?} \text{indicates text missing or illegible when filed}$$

where PMA is microalgae production rate (kg TSS/day), Y yield of microalgae per unit mass of influent nitrogen (g TSS/g N), Q_{In} influent volume rate (m³/day), and SN influent nitrogen concentration (mg N/L).

TABLE 1
Model parameters for ae-MBR/HPO-MBR and nitrification process

| Parameter | Value | | Description | Reference |
|---|---|---|---|---|
| S₀ | 500 | mg COD/L | Influent COD | [18, 25] |
| S₀_NH₄⁺-N | 30 | mg NH₄-N/L | Influent Ammonia | [18, 25] |
| K_{S} | 100 | mg COD/L | Half saturation constant | [25] |
| μₘₐₓ | 6 | g VSS/g VSS/day | Maximum growth rate | [25, 26] |
| K_{D} | 0.12 | g VSS/g VSS/day | Cell decay rate | [25] |
| Y_{aerobic} | 0.4 | g VSS/g COD | Aerobic biomass yield | [25, 26] |
| θ_{H} | 5 | hours | Hydraulic retention time | [25] |
| θ_{C} | 5~20 | days | Mean cell retention time | [18, 25] |
| [symbol] | 0.74 | mg NH₄-N/L | Half saturation constant | [25] |
| [symbol] | 0.75 | g VSS/g VSS/day | Maximum growth rate | [25] |
| K_{D,n} | 0.08 | g VSS/g VSS/day | Cell decay rate | [25] |
| Y_{aerobic,n} | 0.12 | g VSS/g NH₄-N | Aerobic biomass yield | [25] |
| θ_{H,n} | 1.3 | hours | Hydraulic retention time | [25] |
| θ_{C,n} | 15 | days | Mean cell retention time | [25] |

| | | | |
|---|---|---|---|
| Cell formula | C₅H₇NO₂ | Empirical cell formula | [25] |

[symbol]

indicates data missing or illegible when filed

For AnMBR, the biogas production rates rely on biodegraded biomass contents and methane yields per the decayed biomass like

$${P}_{biogas} = {Y}_{biogas} \cdot \text{?} \cdot {R}_{Biomass} \cdot \text{?} \qquad ( 11 )$$

$$\text{?} \text{indicates text missing or illegible when filed}$$

where P_{Biogas} is biogas production rate (m³ biogas/day), YBiogas yield of biogas per unit mass of removed biomass (m³ biogas/kg VSS), Q_{In} influent volume rate (m³/day), R_{Biomass} biomass removal rate (%), XIn influent biomass concentration (mg VSS/L). Table 2 below summaries the modeling parameters used for photo-MBR and AnMBR.

TABLE 2
Model parameters for photo-MBR and AnMBR process

| Parameter | Value | | Description | Reference |
|---|---|---|---|---|
| Y_{MA} | 7.4 | g TSS/g N | Microalgae yield | [4, 19] |
| Algal VSS/TSS | 0.9 | g VSS/g TSS | Ratio of VSS to TSS | [27] |
| Y_{CH4}_MA | 0.42 | L CH/g VSS^{In} | Biogas yield with algae | [27] |
| CH₄ % _{MA} | 70 | % | Methane content | [27, 28] |
| Y_{CH4}_Sludge | 0.32 | L CH₄/g VSS_{In} | Biogas yield with algse | [29] |
| R_{biomass} | 40 | % | Biomass removal | [29] |
| CH₄ % _{sludge} | 60 | % | Methane content | [28] |

| | | | |
|---|---|---|---|
| Algae formula | C₁₀₆H₁₈₁TO₄₅N₁₆P | Empirical algae formula | [30] |

The herein disclosed methods can be based on HPO-MBR processes followed by BNR, as in Scenario I; or photo-MBR, as in Scenario II. SWR3 can be sensitive to the loading rates of organic substrate and nutrients because they determine the oxygen requirement and biomass yield. Oxygen requirement and biomass yield can contribute to the benefits and challenges of SWR3. Therefore, this method can include generating a library of the loading rates with differentiating concentrations of organic compounds and nutrients. F/M ratio and organic loading rate:potential benefits of HPO-MB

To simulate Scenario I and Scenario II, this method applied typical values of key parameters as shown in Table 1 and varied MCRT (θ_{C}) of HPO-MBR to investigate the change of F/M ratio. At the steady state, a general relationship between MCRT and F/M ratio can be derived from Eqn (4) such as

$$\frac{Food}{Microorganism} = \frac{\text{?}}{XV} = \frac{μ}{Y} \qquad ( 12 )$$

$$\text{?} \text{indicates text missing or illegible when filed}$$

If μ in Eqn (12) is replaced with Eqn (6),

$$\frac{Food}{Microorganism} = \frac{1}{\text{?}} ( \text{?} + \frac{1}{{θ}_{C}} ) \qquad ( 13 )$$

$$\text{?} \text{indicates text missing or illegible when filed}$$

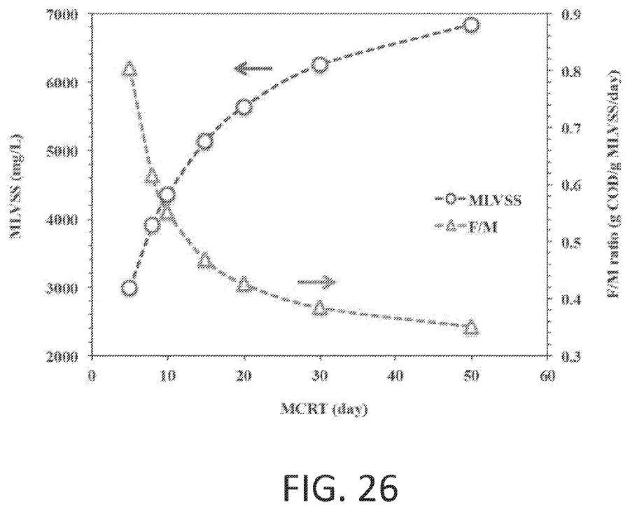

Eqn (13) reveals that MCRT can control F/M ratio in HPO-MBR at the steady state if K_{D} and Y keep constant and that longer MCRT can reduce F/M ratio. As Eqn (13) predicts, the simulation with the model demonstrated that the F/M ratio decreased with MCRT since microorganism concentration in HPO-MBR (i.e., MLVSS) was multiplied as MCRT increased (FIG. 26). Typical values of F/M ratio in CAS/ae-MBR process range from 0.15 to 0.70 kg COD/kg MLVSS/day and, generally, operators of CAS/ae-MBR processes run a low value of F/M ratio to prevent (1) thick foaming problem in bioreactor, (2) DO deficiency under 2 mg/L, and (3) the growth of filamentous bacteria in bioreactors, which seriously deteriorate the settling ability of sludge in clarifier and effluent water quality.

According to the simulation in this method, at least 30 days of MCRT is required to achieve a stable F/M ratio (0.3~0.4 g COD/g MLVSS/day). However, this high value of MCRT demands greater capacity of clarifier to avoid the overflow of its more proliferated microorganisms and, hence, poor water quality. Furthermore, since the increased concentration of microorganisms in the bioreactor impedes the mass transfer of oxygen (as shown in FIG. 1), conventional aeration methods struggle to help the bioreactor escape from deterioration of substrate assimilation by microorganisms.

This limitation of the CAS/ae-MBR process revealed the potential benefits of HPO-MBR process to achieve enough MCRT without losing F/M ratio. First, MBR process can control MCRT readily without any clarifiers because the membrane system can cut off nearly 99% of microbial sludge and retain it in bioreactor securely. Second, the use of pure oxygen can keep a sufficient DO in bioreactor due to its advanced capability of oxygen supply. While the average DO concentration is approximately 0.5-3.0 mg/L for CAS/ae-MBR process, that of HPO process is known 4-8 mg/L. Third, because thick foaming and filamentous bulking can be addressed with higher DO concentration in bioreactor, the enhanced DO concentration with pure oxygen is able to maximize F/M ratio with secure sludge characteristics.

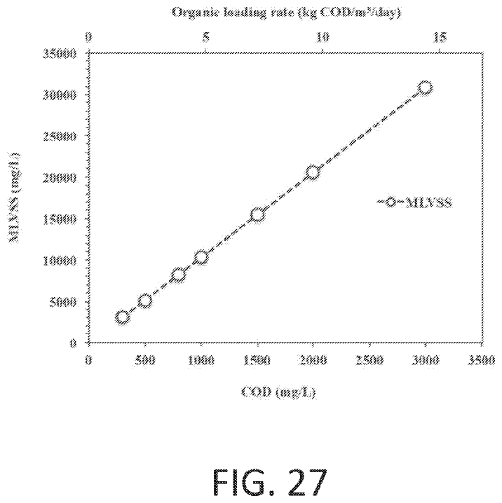

This method simulated the effect of organic loading rate on MLVSS in order to estimate the membrane fouling potential in HPO-MBR. Under assumption that HPO-MBR can improve the F/M ratio of the conventional MBR process, this method applied 0.47 g COD/g MLVSS/day of F/M ratio, which needs 15 days of MCRT. Although they also change dynamically with organic loading rate (OLR) in reality, this simulation assumed constant microbial activities (i.e. K_{D}, Y) with different OLR to avoid a complex modeling. FIG. 27 shows that MLVSS grows proportionally with increase in OLR. Even though it is true for higher biomass concentration in bioreactor to cover higher substrate loading rate, excessive microorganism contents cause a severe membrane fouling and a rising energy cost so that MBR processes typically run 6,000~10,000 mg MLVSS/L of biomass. In this simulation, the maximum OLR of satisfying the stable MLVSS (10,000 mg MLVSS/L) is 5 kg COD/m³/day, which is more than twice as enhanced as the typical OLRs of MBRs (1.0~2.5 kg COD/m³/day).

### Potential Benefits of SWR3

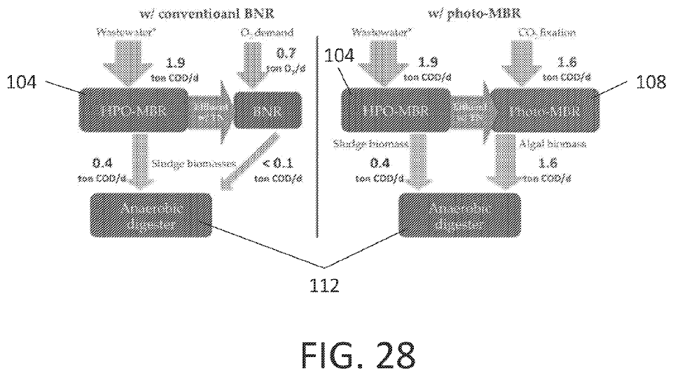

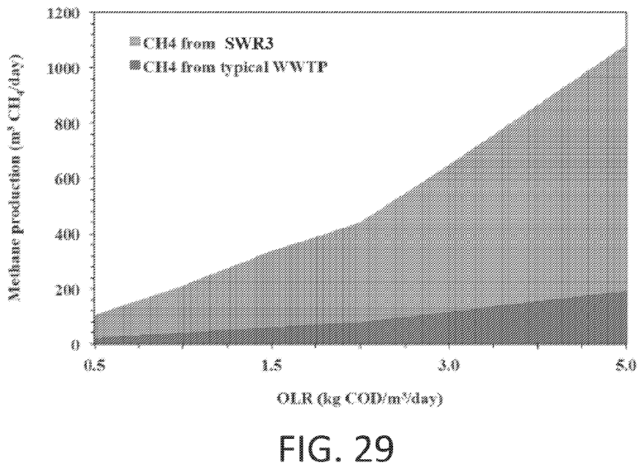

A simulation was performed integrating a microalgae system to ae-MBR/HPO-MBR. While BNR in a conventional WWTP demands the oxygen of over 400 kg/day, algal-MPBR does not require any oxygen to remove the nutrients as shown in FIG. 28. Furthermore, the high yield of algal biomass in algal-MPBR can effectively convert nutrients at the secondary effluent to biomass that is available to be used as bioenergy resource. This high level of biomass yield is led by the facts that microbial growth rate of microalgae is generally higher than that of nitrifying bacteria and that microalgae utilizes CO₂ gas as its carbon source in comparison to nitrifying bacteria requiring organic compounds. Consequently, algal-MPBR is presented to enhance the biogas production in SWR3 about three times that in the typical WWTP as shown in FIG. 29.

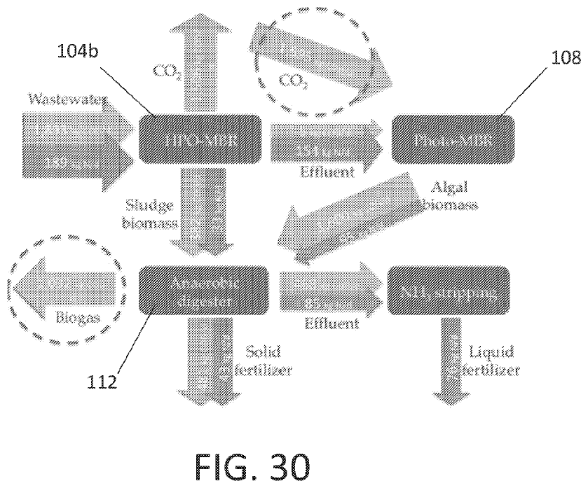

Another potential benefit of the SWR3 is its high rate of CO₂ sequestration. If there is no limit of supplying CO₂ gas into photo-MBR, the microalgae system can capture 1,630 kg CO₂/day (about 1,320 kg COD/day), which is enough to compensate the CO₂ emission from activated sludge process (FIG. 30). In this simulation, no demand of oxygen and external carbon compounds, enhanced biogas production and high rate of CO₂ capture are shown to contribute to the high level of carbon-neutrality of SWR3.

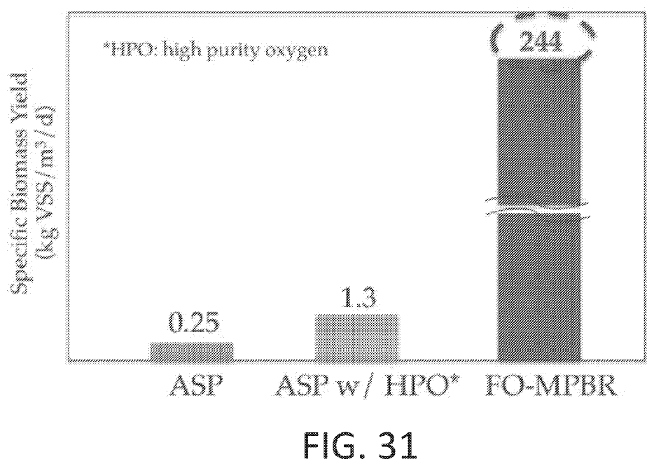

FIG. 31 describes the specific biomass yields of typical ASP, ASP enhanced with pure oxygen and algal-MPBR. Algal-MPBR potentially generates the specific biomass yield much higher than ASP processes. The higher specific biomass yield generally indicates the greater extends of microbial exopolymers like extracellular polymeric substance (EPS), which are excreted by microbes or microalgae. The microbial exopolymers include a variety of adhesive organic substances so that deterioration of membrane fouling is inevitable in the enriched microbial exopolymers, finally causing more sophisticated operation and greater operating expense in the membrane process. FIG. 31 illustrates said specific biomass yields based on the systems and methods described herein.

While the disclosed subject matter is described herein in terms of certain preferred embodiments, those skilled in the art will recognize that various modifications and improvements may be made to the disclosed subject matter without departing from the scope thereof. Moreover, although individual features of one embodiment of the disclosed subject matter may be discussed herein or shown in the drawings of the one embodiment and not in other embodiments, it should be apparent that individual features of one embodiment may be combined with one or more features of another embodiment or features from a plurality of embodiments.

In addition to the specific embodiments claimed below, the disclosed subject matter is also directed to other embodiments having any other possible combination of the dependent features claimed below and those disclosed above. As such, the particular features presented in the dependent claims and disclosed above can be combined with each other in other manners within the scope of the disclosed subject matter such that the disclosed subject matter should be recognized as also specifically directed to other embodiments having any other possible combinations. Thus, the foregoing description of specific embodiments of the disclosed subject matter has been presented for purposes of illustration and description. It is not intended to be exhaustive or to limit the disclosed subject matter to those embodiments disclosed.

It will be apparent to those skilled in the art that various modifications and variations can be made in the method and system of the disclosed subject matter without departing from the spirit or scope of the disclosed subject matter. Thus, it is intended that the disclosed subject matter include modifications and variations that are within the scope of the appended claims and their equivalents.

What is claimed is:

1. A wastewater treatment system, the system comprising:
a membrane bioreactor (MBR), the MBR configured to:
intake influent wastewater and air or high-purity oxygen; and
output effluent comprising sludge solids, carbon dioxide and partially treated water;
an ultrafiltration/microfiltration membrane algal photobioreactor (algal-MPBR) in fluid communication with the MBR, the algal-MPBR configured to:
intake the carbon dioxide and the partially treated water; and
output reuse water and an algal biomass;
an anaerobic digester, the anaerobic digester in fluid communication with the MBR and the algal-MPBR, the anaerobic digester configured to:
intake the sludge solids and the algal biomass; and
output fertilizer, biogas and indirect potable water.

2. The system of claim 1, wherein the MBR comprises a surface aerator, the surface aerator configured to agitate the wastewater and mix the normal air or high-purity oxygen therein.

3. The system of any one of claims 1-2, wherein the MBR comprises a first chamber and a second chamber, each of the first and second chambers comprising a surface aerator.

4. The system of any one of claims 1-3, wherein the MBR comprises a sludge return pipe in fluid communication with at least one of the first and second chambers, configured to return sludge for aeration.

5. The system of any one of claims 1-4, wherein the algal-MPBR comprises at least one immersed ultrafiltration/microfiltration (UF/MF) membrane, the algal-MPBR further comprising microalgae.

6. The system of any one of claims 1-5, wherein the algal-MPBR is configured to cultivate the algal biomass via concentrating a plurality of nutrients in the partially treated water via the UF/MF membrane.

7. The system of claim 6, wherein the plurality of nutrients comprises nitrogen and phosphorous.

8. The system of any one of claims 1-7, wherein the anaerobic digester comprises at least one chamber, the at least one chamber comprising the sludge solids and the algal biomass suspended therein.

9. The system of any one of claims 1-8, wherein the anaerobic digester is configured to off-gas the biogas.

10. The system of claim 9, wherein the biogas is configured to generate H₂, biofuel or electricity.

11. The system of any one of claims 1-10, wherein the output effluent from the MBR comprises dissolved carbon dioxide.

12. The system of any one of claims 1-11, wherein the algal-MPBR is configured to capture the dissolved carbon dioxide output from MBR.

13. The system of any one of claims 1-12, wherein the algal-MPBR is configured to capture the dissolved carbon dioxide via the algal biomass, the algal biomass disposed in at least a chamber of the algal-MPBR.

14. The system of any one of claims 1-13, wherein the algal-MPBR is resistant to membrane fouling.

15. A wastewater treatment method, the method comprising:
providing wastewater to a membrane bioreactor (MBR);
providing normal air or pure oxygen to the MBR;
aerating the wastewater, thereby incorporating the air or pure oxygen into the wastewater;
producing an output effluent, the output effluent comprising sludge solids, partially treated wastewater and gaseous carbon dioxide from the MBR;
providing the partially treated wastewater to an ultrafiltration/microfiltration algal membrane photobioreactor (algal-MPBR);
cultivating algal biomass in the algal-MPBR;
providing the sludge solids to an anaerobic digester;
providing the algal biomass to the anaerobic digester;
producing fertilizer and biogas from the sludge solids and algal biomass by the anaerobic digester.

16. The method of claim 15, wherein the algal-MPBR comprises at least one immersed ultrafiltration/microfiltration (UF/MF) membrane.

17. The method of any one of claims 15-16, wherein the algal-MPBR is configured to cultivate the algal biomass via concentrating a plurality of nutrients in the partially treated water via the UF/MF membrane.

18. The method of any one of claims 15-17, wherein aerating the wastewater comprises aerating the wastewater in at least two stages, each of the stages disposed in a distinct chamber of the MBR.

19. The method of any one of claims 15-18, wherein the biogas is configured to generate H₂, biofuel or electricity.

20. The method of any one of claims 15-19, wherein the output effluent from the MBR comprises dissolved carbon dioxide.

21. A wastewater treatment system, the system comprising:
a staged membrane bioreactor (MBR), the MBR having at least two stages in fluid communication, each stage configured to:
intake influent wastewater and air or high-purity oxygen;
aerate the influent wastewater with the air or high-purity oxygen; and
output effluent comprising sludge solids, carbon dioxide and partially treated water;
a membrane algal photobioreactor (algal-MPBR) in fluid communication with the staged MBR, the algal-MPBR configured to:
intake the carbon dioxide and the partially treated water; and
output reuse water and an algal biomass;
an anaerobic digester, the anaerobic digester in fluid communication with the MBR and the algal-MPBR, the anaerobic digester configured to:
intake the sludge solids and the algal biomass; and
output at least one of fertilizer, biogas and indirect potable water.

22. The system of claim 21, wherein the at least two stages of the staged MBR are in fluid communication.

23. The system of any one of claims 21-22, wherein at least one stage of the staged MBR comprises a surface aerator disposed therein.

24. The system of any one of claims 21-23, wherein the algal-MPBR comprises at least one chamber in fluid communication with the staged MBR and the anaerobic digester, the at least one chamber comprising at least microalgae.

25. The system of any one of claim 21-24, wherein the algal-MPBR is configured to circulate microalgae through the at least one chamber.

26. The system of any one of claims 21-25, wherein the at least one chamber of the algal-MPBR comprises perforations capable of passing the partially treated wastewater.

27. The system of any one of claims 21-26, the algal-MPBR comprises at least one filter configured to capture nutrients from the partially treated wastewater.

28. The system of claim 27, wherein the algal MPBR comprises a plurality of filters having varied pore sizes, the plurality of filters configured to capture a plurality of distinct nutrients according to their respective sizes.

29. The system of any one of claims 21-28, wherein the microalgae are disposed in the algal-MPBR proximate to the plurality of filters.

30. The system of any one of claims 21-29, wherein the anaerobic digester comprises a slot in fluid communication with the staged MBR, the slot configured to receive the sludge solids within the anaerobic digester.

31. The system of any one of claims 21-30, further comprising at least one clarifier in fluid communication with the staged MBR and the algal-MPBR.

32. The system of any one of claims 21-31, wherein the at least one clarifier comprises a primary clarifier in fluid communication with the MBR and the anaerobic digester.

33. The system of any one of claims 21-32, wherein at least a portion of the sludge solids are recycled within the MBR, wherein the recycled sludge solids are transported between the second stage and the first stage.

34. The system of any one of claims 21-33, further comprising a steam-powered electric generator in fluid communication with the anaerobic digester.

35. The system of any one of claims 21-33, wherein the MBR, algal-MPBR and anaerobic digester are in fluid communication via a plurality of fluid conduits.
